(19) United States
(12) Patent Application Publication
(10) Pub. No.: US 2024/0235277 A1
(43) Pub. Date: Jul. 11, 2024

(54) CAPABILITY SIGNALING FOR WIRELESS ENERGY HARVESTING

(71) Applicant: QUALCOMM Incorporated, San Diego, CA (US)

(72) Inventors: Ahmed ELSHAFIE, San Diego, CA (US); Yi HUANG, San Diego, CA (US); Sony AKKARAKARAN, Poway, CA (US); Alexandros MANOLAKOS, Escondido, CA (US)

(21) Appl. No.: 18/288,948

(22) PCT Filed: Jun. 17, 2022
(86) PCT No.: PCT/US2022/034040

§ 371 Date: Oct. 30, 2023

(30) Foreign Application Priority Data
Jun. 28, 2021 (GR) 20210100431

(51) Int. Cl. H02J 50/80; H02J 50/00; H02J 50/20

(52) U.S. Cl. CPC H02J 50/80; H02J 50/001; H02J 50/20

(57) ABSTRACT

Aspects of the present disclosure include methods and devices for energy harvesting (EH). An EH device may be configured to transmit, to an energy transfer (ET) device or a base station, an indication of an EH capability of the EH device. The ET device may be configured to transmit, to the EH device or the base station, an indication of an ET capability of the ET device. The ET device may also be configured to receive a request to transmit RF energy to the EH device. The base station may also be configured to configure transmission of RF energy from at least one ET device to the EH device based on the at least one indication of the EH capability. The EH device may also be configured to receive, and the ET device may be configured to transmit, based on the transmitted indication, RF energy.

### CROSS-REFERENCE TO RELATED APPLICATION

This application claims the benefit of Greek Application No. 20210100431, entitled “CAPABILITY SIGNALING FOR WIRELESS ENERGY HARVESTING” and filed on Jun. 28, 2021, which is expressly incorporated by reference herein in its entirety.

### BACKGROUND

### Technical Field

The present disclosure relates generally to communication systems, and more particularly, to energy harvesting (EH) at user equipments (UEs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects of wireless communication, e.g., 5G NR, some devices (e.g., UEs, IoT devices, wearable devices, etc.) are capable of performing EH operations. RF EH operations may provide controllable and constant energy transfer. Different devices may support energy transfer (ET) for different EH architectures of a target EH device, via different time-and-frequency resources, or via different waveforms. Aspects presented herein provide for identification of EH characteristics of an EH-capable device (e.g., UE, IoT device, wearable device, etc.) and of ET characteristics of nearby ET-capable devices (e.g., base station, UE, IoT device, wearable device, etc.) to enable the negotiation of an EH operation between different EH/ET-capable devices.

In an aspect of the disclosure, a method, a computer-readable medium, and an apparatus are provided. The apparatus may be a device at a UE. The device may be a processor and/or modem at a UE or the UE itself. The UE may be configured to transmit an indication of an EH capability of the UE. The UE may also be configured to receive, based on the transmitted indication, transmitted RF energy from at least one RF ET node. The UE may further be configured to transmit a requested charging rate. The UE may also be configured to receive information regarding a set of EH resource-and-capability configurations; and receive an indication of a particular EH resource-and-capability configuration, where receiving the transmitted RF energy is further based on the received indication of the particular EH resource-and-capability configuration.

In an aspect of the disclosure, a method, a computer-readable medium, and an apparatus are provided. The apparatus may be a device at a UE. The device may be a processor and/or modem at a UE or the UE itself. The UE may be configured to transmit an indication of an ET capability of the ET device. The UE may also be configured to receive a request to transmit RF energy to an EH capable UE. The UE may further be configured to transmit, based on the received request, RF energy to the EH-capable UE. The UE may be configured to indicate a set of frequencies supported for data transmission. The UE may also be configured to transmit an indication of a current ability of the ET device to serve as an ET node based on a power level of the ET device. The UE may further be configured to stop transmission of the RF energy based on a timer expiring following transmission of a last indication of the current ability of the ET device to serve as the ET node and before the transmission of a next of the indication of the current ability of the ET device to serve as the ET node. The UE may be configured to receive a set of ET resource configurations; and receive an indication of at least one particular ET resource configuration, where transmitting the RF energy is further based on the received indication of the particular ET resource configuration.

In an aspect of the disclosure, a method, a computer-readable medium, and an apparatus are provided. The apparatus may be a device at a base station. The device may be a processor and/or modem at a base station or the base station itself. The base station may be configured to receive at least one indication of an EH capability from one or more of an ET device or an energy reception device. The base station may also be configured to configure transmission of RF energy from at least one ET device to the energy reception device based on the at least one indication of the EH capability. The base station may further be configured to transmit information regarding a set of EH resource-and-capability configurations; and transmit an indication of a particular EH resource-and-capability configuration for use by at least one of the ET device or the energy reception device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating components of an example RF-energy-harvesting-capable device (e.g., a UE, wearable device, etc.).

FIG. 5 is a set of diagrams each illustrating different RF energy harvesting and RF communication architectures for an RF-energy-harvesting-capable device.

FIG. 6 is a diagram illustrating components of an example network.

FIG. 7 is a diagram illustrating a set of time-and-frequency resources for SL communication.

FIG. 8 includes a diagram of a set of time-and-frequency resources for an SPS configuration configured by RRC configuration.

FIG. 9 is a call flow diagram illustrating an EH device negotiating an EH operation with an ET device via a base station.

FIG. 10 is a call flow diagram illustrating an EH device engaging in an EH operation with an ET device that is updated via a base station.

FIG. 11 is a call flow diagram illustrating an EH device negotiating an EH operation with an ET device via a base station.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus.

FIG. 19 is a diagram illustrating an example of a hardware implementation for an example apparatus.

FIG. 20 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

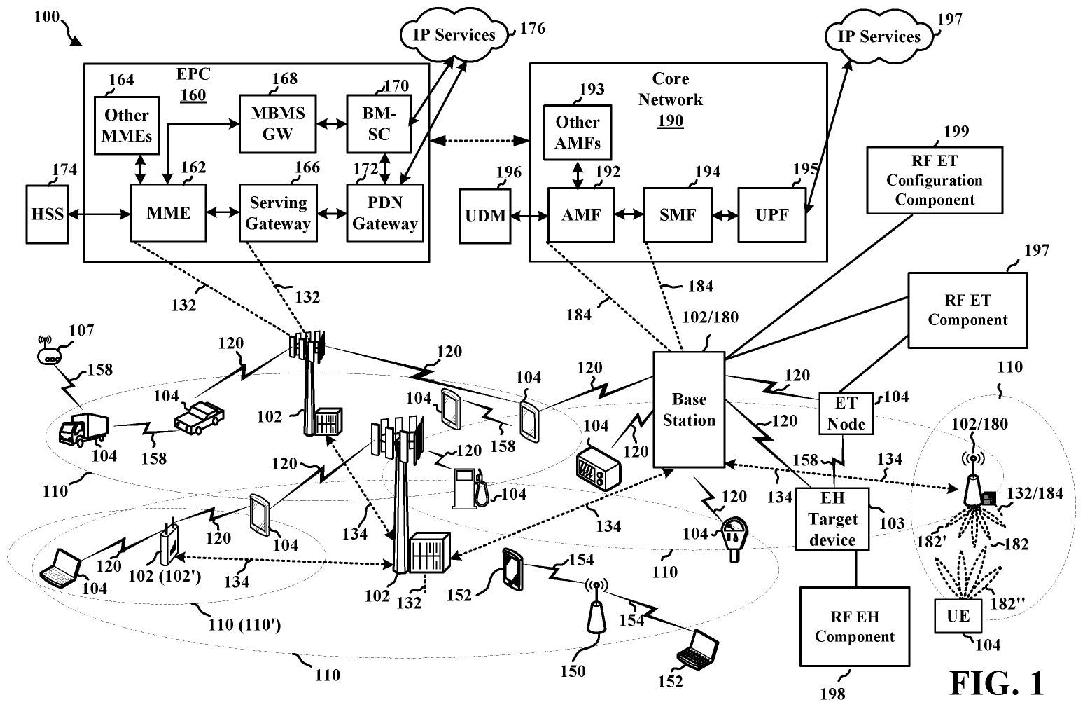

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, an EH target device 103 may include an RF EH component 198 that may be configured to transmit an indication of an EH capability of the UE and to receive, based on the transmitted indication, transmitted RF energy from at least one (RF) ET node. The EH target device 103 may be a UE 104 or another device that is capable of receiving an RF signal. In certain aspects, a wireless device that is capable of transmitting an RF signal (e.g., such as a base station 102, 180, UE 104, etc.) may include an RF ET component 197 configured to transmit an indication of an ET capability of the ET device. The RF ET component 197 may be configured to receive a request to transmit RF energy to an EH-capable UE and to transmit, based on the received request, RF energy to the EH-capable UE. In certain aspects, the base station 102 or 180 may include an RF ET configuration component 199 that may be configured to receive at least one indication of an EH capability from one or more of an ET node or an EH target device and to configure transmission of RF energy from at least one ET device to the energy reception device based on the at least one indication of the EH capability. Although the following description may be focused on 5G NR, the concepts described herein may be applicable to other similar areas, such as LTE, LTE-A, CDMA, GSM, and other wireless technologies.

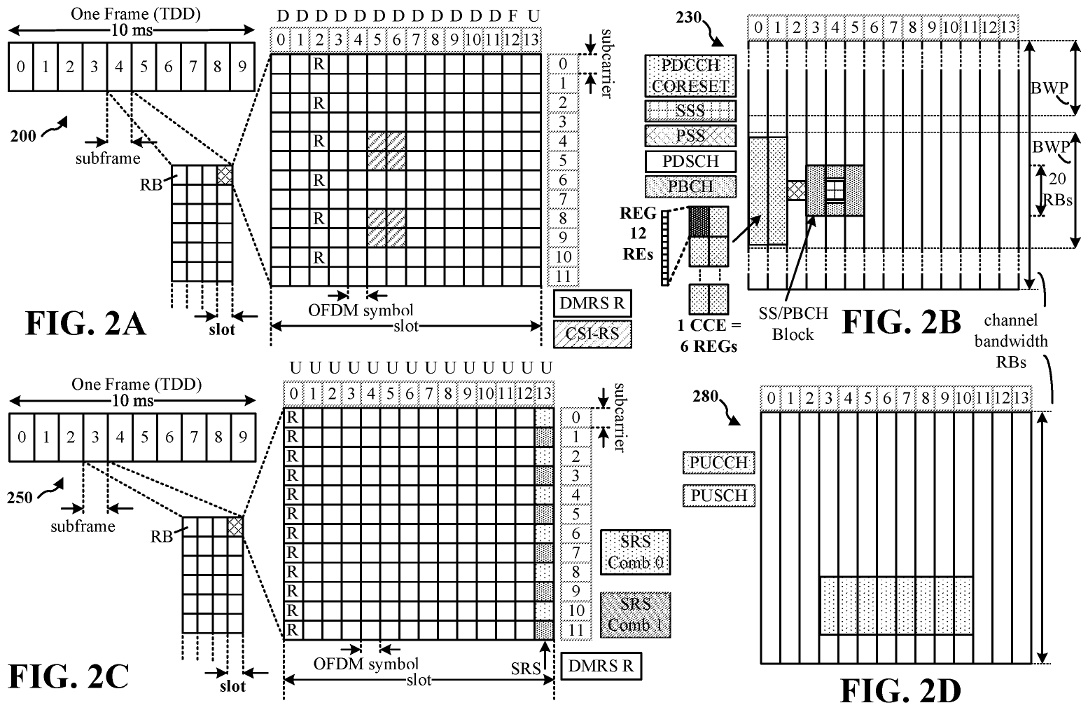

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on whether the cyclic prefix (CP) is normal or extended. For normal CP, each slot may include 14 symbols, and for extended CP, each slot may include 7 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δƒ = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

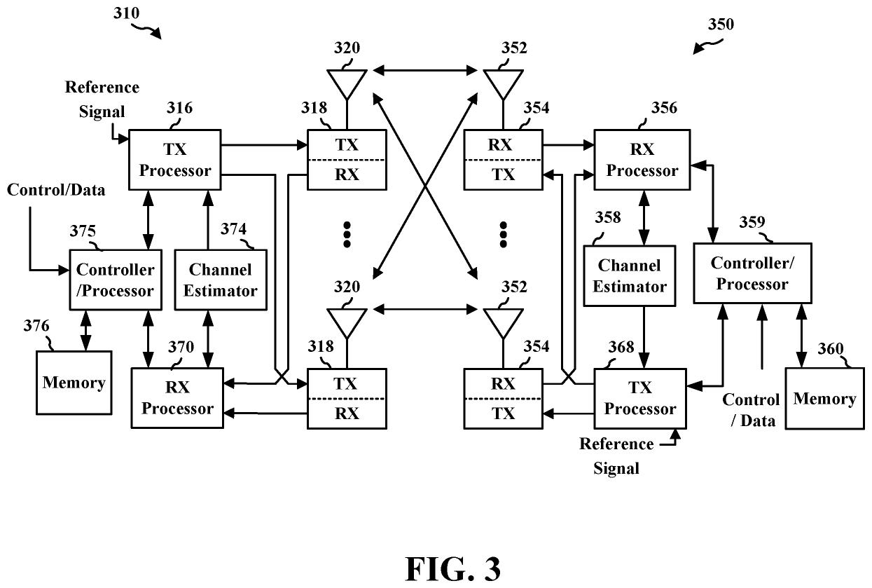

FIG. 3 is a block diagram of a first wireless device 310 in communication with a second wireless device 350, e.g., in an access network. In some aspects, one of the wireless devices may include an EH device that harvests energy from an RF signal received from the other wireless device, as presented herein. In some aspects, one of the wireless devices may be an ET device that transmits an RF signal to the other wireless device as part of an EH operation. In some aspects, one of the wireless devices may be a base station that configures the other wireless device to receive RF energy from an ET device or to transmit RF energy to an EH target device.

The wireless devices may support wireless communication. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. As an example, if the wireless device 310 is a base station and the wireless device 350 is a UE, in the DL, IP packets from the EPC 160 may be provided to a controller/processor 375. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the wireless device 350. Each spatial stream may then be provided to a different antenna 320 via a separate transmitter 318 TX. Each transmitter 318 TX may modulate a radio frequency (RF) carrier with a respective spatial stream for transmission.

At the wireless device 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the wireless device 350. If multiple spatial streams are destined for the wireless device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the wireless device 310. These soft decisions may be based on channel estimates computed by the channel estimator 358. The soft decisions are then decoded and deinterleaved to recover the data and control signals that were originally transmitted by the wireless device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the wireless device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the wireless device 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The UL transmission is processed at the wireless device 310 in a manner similar to that described in connection with the receiver function at the wireless device 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the wireless device 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 368, the RX processor 356, and the controller/processor 359 may be configured to perform aspects in connection with 197 of FIG. 1. At least one of the TX processor 316, the RX processor 370, and the controller/processor 375 may be configured to perform aspects in connection with 197 of FIG. 1. At least one of the TX processor 316, the RX processor 370, and the controller/processor 375 may be configured to perform aspects in connection with 199 of FIG. 1.

In some aspects, a wireless device may be capable of transferring or harvesting RF energy. RF energy harvesting may provide controllable and constant energy transfer over distance. In some aspects, the wireless devices may be a wireless communication device that support transferring or harvesting RF energy. For example, in some aspects, an RF signal may be used for communication, and in other aspects the RF signal may be used for energy transfer or energy harvesting. In a fixed RF energy harvesting network, the harvested energy may be predictable and relatively stable over time due to fixed distance. Additionally, a full-duplex (FD) and EH-capable UE (e.g., a UE that can transmit data and receive/harvest energy) may be able to capture some of its own transmitted energy. In some aspects, using a random multipath fading channel model, the energy harvested at node j (Eⱼ) from a transmitting node i may be given by Eⱼ=ηPᵢ|gᵢⱼ|²T (Eq. 1), where Pᵢ is a transmit power at node i, gᵢⱼ is a channel coupling coefficient of the link between node i and node j, T is the time allocated for energy harvesting, and η is an RF-to-DC (direct current) conversion efficiency.

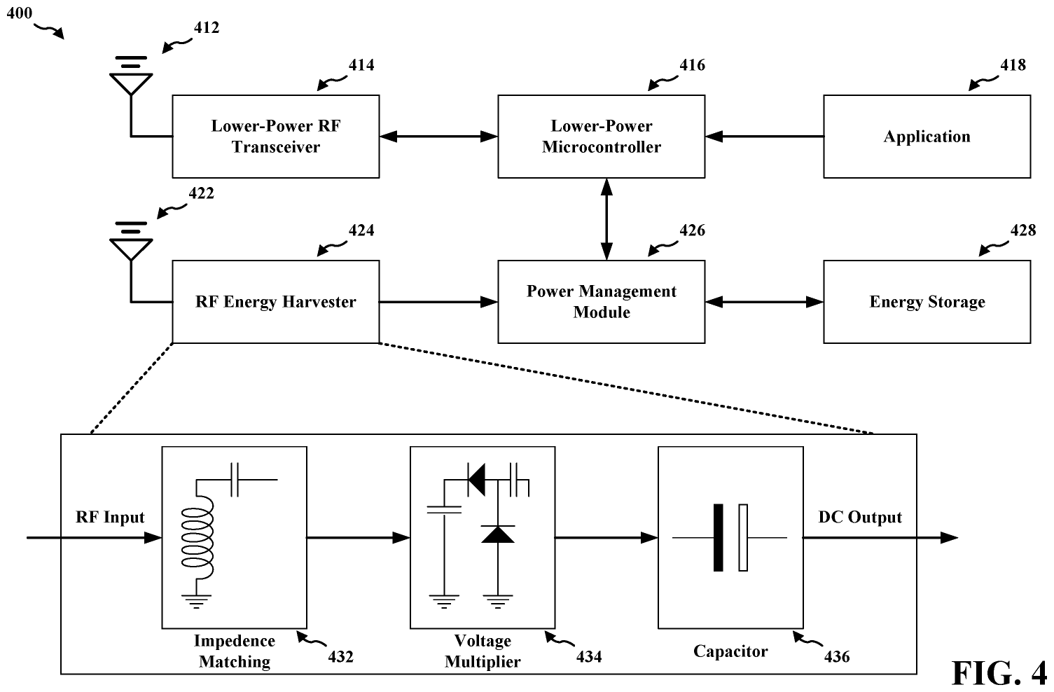

FIG. 4 is a diagram 400 illustrating components of an example RF EH-capable device (e.g., a UE, wearable device, network node, etc.). Diagram 400 illustrates a set of components 412-418 for a data transmission pipeline. Antenna 412 and RF transceiver 414 (e.g., a low power RF transceiver) may transmit and/or receive data. A microcontroller 416 (e.g., a low power microcontroller) may process data received from an application 418.

Diagram 400 further illustrates a set of components 422-428 for an RF-energy-harvesting pipeline. An antenna 422 and an RF energy harvester 424 may harvest RF energy. The RF energy harvester 424 may include an impedance matching circuit 432, a voltage multiplier 434, and a capacitor 436 to collect RF signals and convert them into electricity. A power management module 426 may decide whether to store the electricity obtained from the RF energy harvester 424 or to use it for information transmission immediately. An energy storage 428 (e.g., a battery) may store energy converted by the RF energy harvester 424.

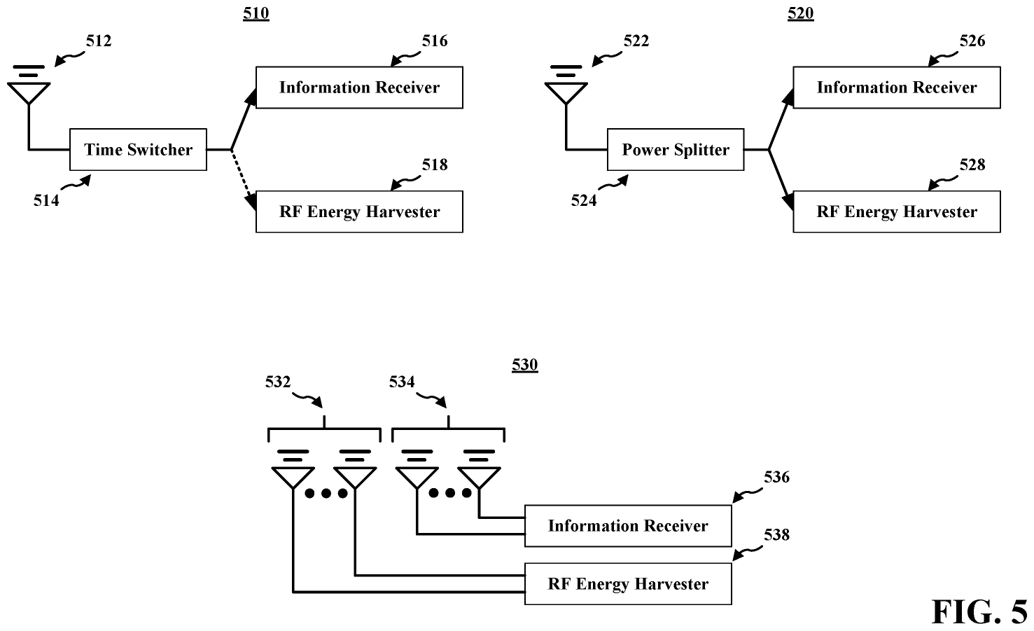

FIG. 5 is a set of diagrams 510-530 each illustrating different RF energy harvesting and RF communication architectures for an RF EH-capable device. Diagram 510 illustrates an antenna 512 connected to a time switcher 514. Time switcher 514 may allow an RF-energy-harvesting-capable device to switch between (1) being connected to an information receiver 516 and (2) being connected to an RF energy harvester 518. For example, the device may exchange wireless communication and RF energy at different, e.g., non-overlapping, times. In a time-switching RF energy harvesting architecture (mode of operation) the energy harvested at a receiver node j (Eⱼ) from a transmitter node i may be given by Eⱼ=ηPᵢ|gᵢⱼ|²αT, where α∈[0,1] is a fraction of time allocated for energy harvesting with other variables defined as in Eq. 1 above described in relation of FIG. 4. Additionally, for a noise spectral density, κ, and a channel bandwidth, W, a data rate (Rᵢⱼ) for communication between a receiver node j from a transmitter node i may be given by

$${R}_{i j} = ( 1 - α ) {log}_{2} ( 1 + \frac{{P}_{i} {\vert {g}_{i j} \vert}^{2}}{κ W} ) .$$

Diagram 520 illustrates an antenna 522 connected to a power splitter 524. Power splitter 524 may allow an RF-energy-harvesting-capable device to distribute power between (1) an information receiver 526 and (2) an RF energy harvester 528. For example, the device may exchange wireless communication and RF energy at overlapping times. A received RF signal may be split into two streams, with one stream for the information receiver and the other stream for the RF energy harvester. In a power splitting RF energy harvesting architecture (mode of operation) the energy harvested at a receiver node j (Eⱼ) from a transmitter node i may be given by Eⱼ=ηPᵢ|gᵢⱼ|²ρT, where ρ∈[0,1] is a fraction of power allocated for energy harvesting with other variables defined as in Eq. 1 above described in relation of FIG. 4. Additionally, for a noise spectral density, κ, and a channel bandwidth, W, a data rate (Rᵢⱼ) for communication between a receiver node j from a transmitter node i may be given by

$${R}_{i j} = {log}_{2} ( 1 + \frac{( 1 - ρ ) {P}_{i} {\vert {g}_{i j} \vert}^{2}}{κ W} ) .$$

Diagram 530 illustrates a separated receiver architecture. A set of antennas 532 is associated with an RF energy harvester 538 while a set of antennas 534 is connected to information receiver 536. For example, diagram 400 illustrates a separated receiver architecture.

As non-limiting examples of waveforms for RF energy transfer, RF energy transfer may occur via one or more of a deterministic signal (e.g., a pilot signal), a random signal such as a circularly symmetric complex Gaussian random signal, and/or an improper complex Gaussian random signal (e.g., a signal in which Real and Imaginary components have different variances). The RF energy transfer signals, in some aspects, are generated via a pseudo-random generator.

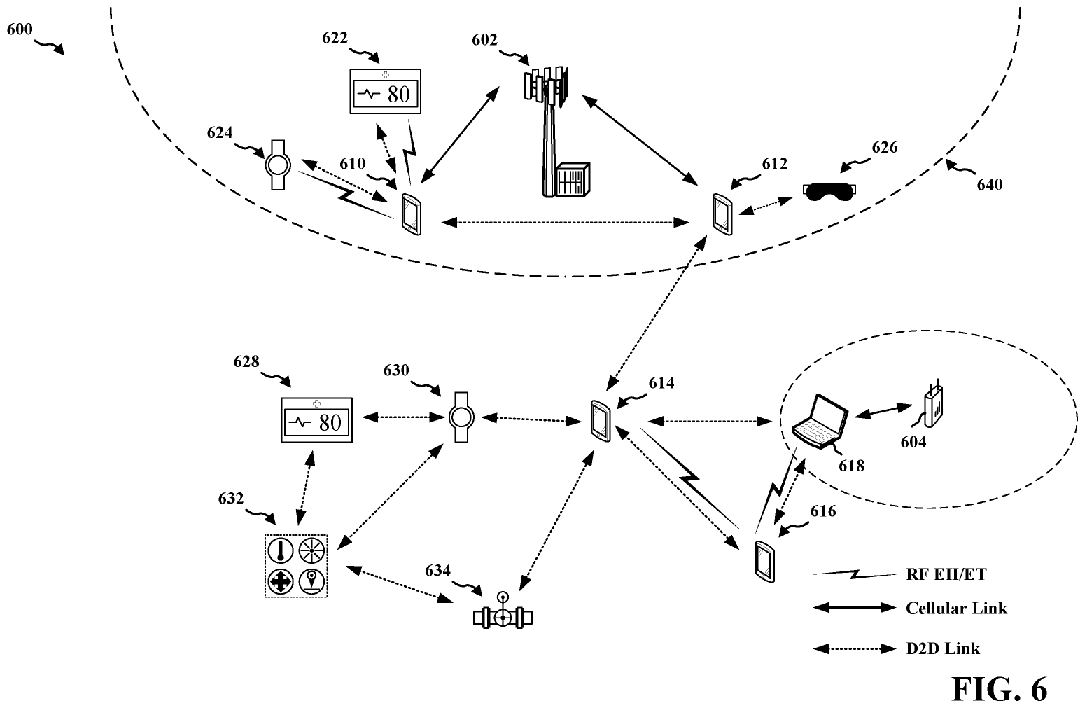

FIG. 6 is a diagram 600 illustrating components of an example network. Diagram 600 illustrates an example network including a base station 602 (e.g., as an example of a base station 102), a small cell base station 604 (similar to small cell 102′ of FIG. 1), a set of UEs 610-618, and other devices 622-634 (e.g., smart devices, sensors, etc.). The UEs 610 and 612 may be in a coverage area 640 of base station 602 and may be in communication with the base station 602. For example, the UEs 610 and 612 may communicate with the base station 602 and may communicate with each other via SL. Resources for SL communication between UE 610 and 612 may be controlled and/or configured by the base station 602. Similarly, the UE 618 (e.g., laptop, or other customer-premises/provided equipment (CPE)) may be connected to the small cell base station 604 via a first type of communication session (e.g., a WiFi connection or Uu connection) and to additional UEs 614 and 616 via a second type of connection (e.g., a SL connection). Additionally, UE 610 may also be serving as an ET node for providing RF energy to devices 622 and 624, while UE 616 may be receiving energy from multiple other ET devices (e.g., laptop 618 and UE 614) as directed by the network via base stations 602 and 604 and, for UE 616, via at least one of laptop 618 and UE 614 providing access to the network to UE 616 (e.g., as a relay).

The UEs 614 and 616 may be out of a coverage area of the base station 602 and may communicate with each other and/or at least one of UE 610 and 612 via SL. The UE 614 may also be in communication with base station 602 via the UE 612 (e.g., with the UE 612 operating as a relay device) and the additional devices 626-634 via SL, e.g., which may be referred to as partial coverage operation. In some aspects, the connection with the additional devices may be via a Bluetooth™ connection or via an unlicensed spectrum. The SL communication between the UE 614 and the UE 616 may be via pre-configured SL provisioning information for discovery and/or communication support (e.g., pre-configured SL resources) without dynamic input from the base station 602.

In some aspects, one or more of the devices may include a wearable device, sensor, or other device that connects to a network via a UE. As an example, a smartwatch, health monitoring device, or other wearable may exchange communication with a base station via a UE. The wearable may communicate with the UE over sidelink, and the UE may provide a UE to network relay operation. As another example, an extended reality (XR) device may have a sidelink connection with a UE, and the UE may provide a UE to network relay operation for the XR device. As another example, a sensor may exchange communication with a UE (as well as other sensors) via sidelink, and the UE may relay communicate for the sensor with the network. Multiple sensors may communicate, e.g., over sidelink, to form a mesh network using UE to UE relay of communication. As an example, smart home appliances such as a smart thermostat and an entry key may exchange communication over sidelink.

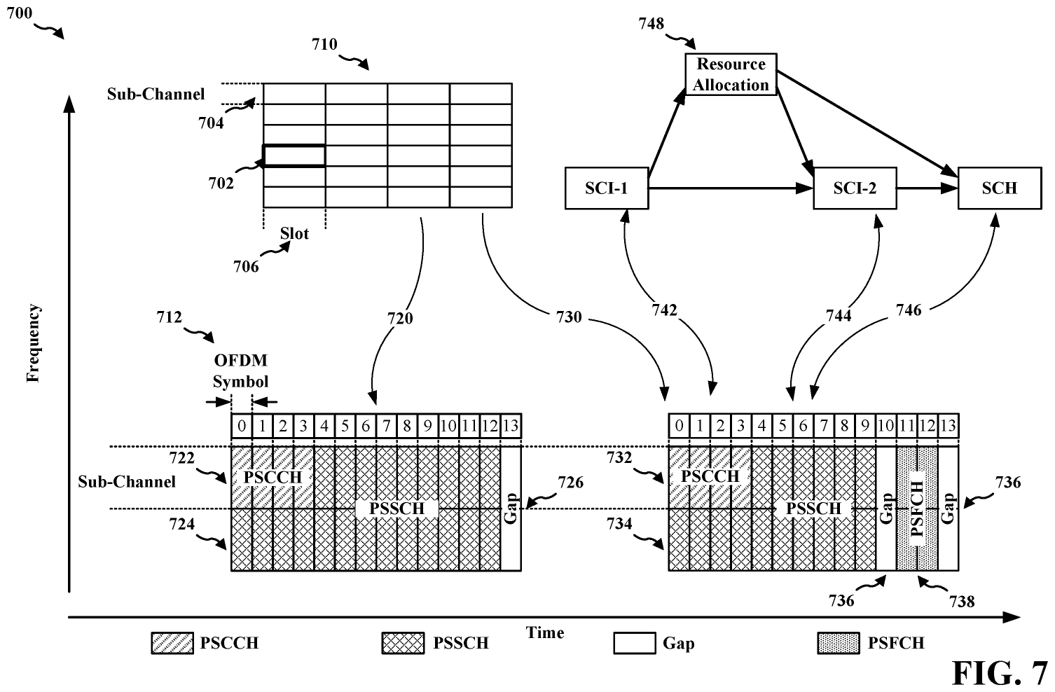

FIG. 7 is a diagram 700 illustrating a set of time-and-frequency resources 710 for sidelink (SL) communication. In some aspects, the set of time-and-frequency resources 710 for SL communication are divided into reservable/allocable time-and-frequency resource units, e.g., time-and-frequency resource unit 702. The time-and-frequency resource unit 702, in some aspects, span one sub-channel 704 in frequency and span one slot 706 in time. The sub-channels 704 may by (pre)configured to include one of 10, 15, 20, 25, 50, 75, or 100 PRBs. Some slots may not be available/allocable for SL. The set of time-and-frequency resources 710 may be pre-configured (e.g., pre-loaded on a UE) or may be configured by a base station (e.g., via an RRC message).

In some aspects, a slot may include 14 OFDM symbols (e.g., OFDM symbol 712), while fewer than 14 symbols may be (pre)configured for SL data. A first symbol (e.g., symbol “0”) may be repeated in a preceding symbol for automatic gain control (AGC) settling. An SL-allocable slot 720 may include a first set of symbols in a first set of sub-channels including PSCCH 722, a second set of symbols in a second set of sub-channels including PSSCH 724, and a gap symbol 726 that may follow the PSSCH symbols 724. An SL-allocable slot 730 may include a first set of symbols in a first set of sub-channels including PSCCH 732, a second set of symbols in a second set of sub-channels including PSSCH 734, a first gap symbol 736 that may follow the PSSCH symbols 734, a third set of symbols in a third set of sub-channels including PSFCH 738, and a second gap symbol 736 that may follow the PSFCH 738. The third set of symbols in the third set of sub-channels including PSFCH 738 may include a first symbol of PSFCH and a second symbol that is a repetition of the first PSFCH symbol for AGC settling. In some aspects, PSCCH and PSSCH may be transmitted in a same slot. In some aspects, slots including PSFCH may be configured with a period of 0, 1, 2, or 4 slots.

SL control information (SCI) may include a first stage of control information (e.g., SCI-1 742) that is transmitted via PSCCH and may contain information for resource allocation (e.g., resource allocation 748) and for decoding second stage control information (e.g., SCI-2 744). Second stage control information (e.g., SCI-2 744) may be transmitted via PSSCH and may contain information for decoding data in a shared channel (e.g., SCH 746). In some aspects SCI-1 may be decodable for UEs in multiple releases, while new SCI-2 formats may be introduced in future releases. Both SCI-1 and SCI-2, in some aspects, may be transmitted via a PDCCH polar code.

As discussed in relation to FIGS. 4-7 different devices may support different architectures, time-and-frequency resources, or different waveforms. Specifically, in a mixed network as described in relation to FIG. 6, different devices may differently support RF ET/EH capabilities. In such cases, it may be beneficial to introduce methods for identifying (e.g., indicating or communicating) common characteristics (or negotiating time-and-frequency resources and waveforms) for an EH operation between different EH/ET-capable devices. Aspects presented herein enable an EH target device and/or an ET device to indicate one or more EH related capabilities in an efficient manner.

A wireless device may support full duplex operation in which the device transmits and receives in a same frequency range. The frequency range may include a common set of frequency bands (e.g., the same frequency bands), fully overlapping frequency bands, or partially overlapping frequency bands. For example, in-band full duplex (IBFD) operation may include the transmission and reception of signals at overlapping times and overlapping in frequency. In sub-band FDD, transmission and reception resources may overlap in time using different frequencies, e.g., separated by a guard band. The transmission and reception frequency resources may be close enough that interference cancellation methods are used to cancel interference from the transmitted signal.

A device that supports FD operation may operate in a half-duplex (HD) mode (with transmission and reception at non-overlapping times). The use of a FD mode may be further based on a capability of another device with which the device is exchanging communication, spectral efficiency, power consumption (e.g., a trade-off between spectral efficiency and power consumption), interference conditions that affect an achievable FD gain, etc. A TDD device may operate based on HD operation in which the device does not transmit and receive at a same time on a same frequency range.

In some aspects, an EH device or an ET device may support full duplex operation in which the EH device supports transmitting a signal and receiving RF energy from the signal, which may enable the EH device to recycle its own energy.

As an example of an EH device, a UE may indicate such a capability that relates to EH and FD operation to the base station. Although described for the example of a UE, the capability may similarly be indicated by other EH devices. In some aspects, the UE may indicate to the base station whether or not the UE supports wireless EH (e.g., which may be referred to as CAP0). In some aspects, the ULE may indicate whether the UE supports FD operation in connection with wireless EH (e.g., which may be referred to as CAP1). The capability may be indicated from multiple possible capabilities. For example, the UE may indicate support for full-duplex transmission of data and reception of RF energy at overlapping times (e.g., which may be referred to as CAP 10). The UE may indicate support for full-duplex communication operation, e.g., transmission and reception of data at overlapping times without EH (which may be referred to as CAP 11). The UE may indicate support for transmission of data, reception of data, and reception of RF energy (e.g., which may be referred to as CAP12).

The base station may use the capability information received from the UE to schedule resources for the UE. In some aspects, the base station may indicate for the UE to switch between capabilities, e.g., to address impact of capability on achievable rates, interference in a received signal at a FD receiver, reduction in data decoding, etc. The base station may indicate for the UE to use a particular capability for a period of time, e.g., a number of slots, frames, etc.

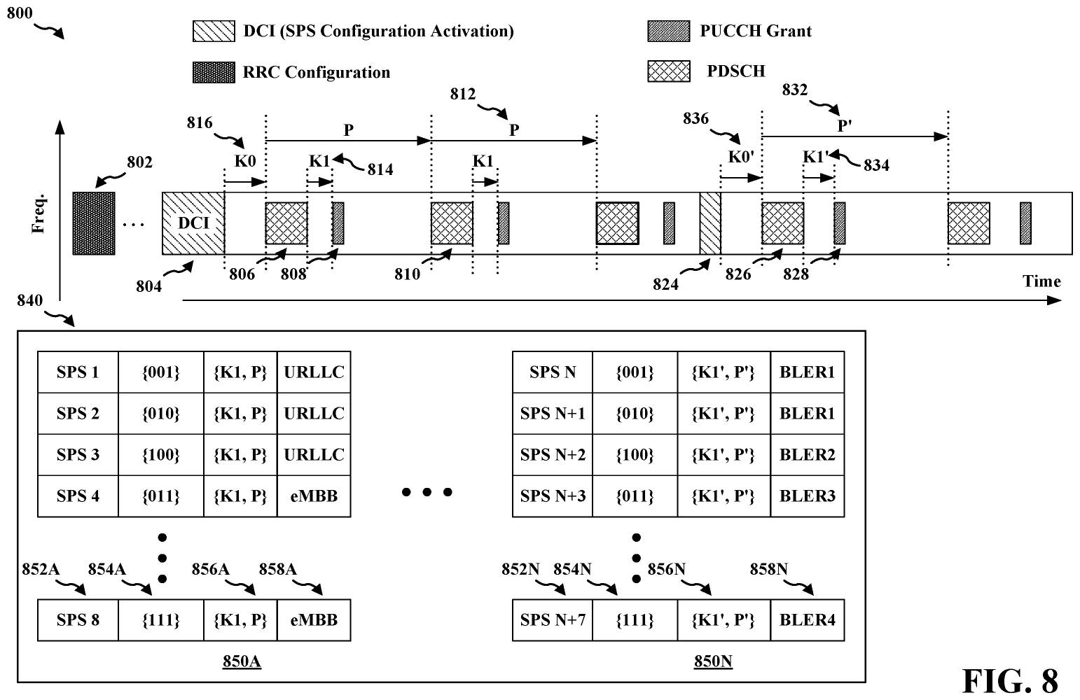

FIG. 8 includes a diagram 800 of a set of time-and-frequency resources for an SPS configuration configured by RRC configuration 802. RRC configuration 802 may be received at a device (EH device or ET device) and may include a set of SPS configurations 840. An SPS configuration may include a periodicity 812/832 (P/P′) between a first SPS occasion 806 and a subsequent SPS occasion 810 and a time-offset 814/834 (K1/K1′) between an SPS PDSCH resource 806/826 and a PUCCH grant 808/828 for transmitting HARQ-ACK/NACK feedback for the SPS PDSCH resource 806/826. A DCI 804/824 including activation (or deactivation) information for at least one received SPS configuration may be received at the ET device or the EH device. The DCI may identify (or otherwise indicate) an activated SPS configuration and may include an additional time-offset 816/836 (K0/K0′) between the DCI 804/824 and the first reception occasion 806/826 of the activated SPS configuration. Additional parameters relating to the SPS occasions of an activated SPS configuration such as a modulation and coding scheme (MCS), an RB allocation (to identify a set of frequency resources during the reception occasions), antenna ports, etc. may be indicated in DCI 804/824.

The set of SPS configurations 840 may include multiple subsets of SPS configurations 850A-850N. Each SPS configuration may include an identifier (e.g., “SPS 8” 852A or “SPS N+7” 852N), a capability indicator (e.g., indicators 854A and 854N), and a set of SPS parameters (e.g., parameters 856A and 856N including a period (P/P′) and a time-offset (K1/K1′) for transmitting ACK/NACK). An SPS configuration may be associated with a particular application, traffic type (e.g., URLLC, eMBB, high-quality-of-service (QoS) traffic, or low-QoS traffic, etc.), a traffic density, or an error rate (e.g., a block error rate (BLER) or signal-to-noise ratio (SNR)) by a policy or criteria 858A/858N. The SPS identifier (e.g., identifier 852A) may be used to identify a particular SPS configuration (e.g., SPS 1, SPS 2, etc.) in a subsequent activation or modification operation, e.g., in DCI 804/824 used to activate a configuration or in a MAC control element (MAC-CE) that may be used to update a configuration (not shown). The capability indicator may be a value (e.g., an N-bit value) indicating whether each of a set of N capabilities is activated during each of the SPS PDSCH resources (and during the PUCCH grant). For example, an EH or ET device may be capable of transmitting data, receiving data, and performing an EH/ET operation (e.g., N=3), and each bit in a three-bit value may indicate whether a particular capability is activated for the SPS PDSCH resources and PUCCH grant.

As illustrated in FIG. 8, the set of SPS configurations 840 may include multiple subsets of SPS configurations 850A-850N with a same set of SPS parameters 856, e.g., {K1, P} or {K1′, P′}, but each with a different capability indicator value 854. In some aspects, multiple configurations with a same set of SPS parameters may be activated with different time-offsets (e.g., time-offset 816/836 (K0/K0′)) to initiate a combined communication and EH/ET operation between two particular devices. For example, for a URLLC communication between an EH device and an ET device, the base station (or EH/ET device for a device-mediated EH/ET operation) may determine that, for the EH device, every 100 ms one of (1) data transmission and EH or (2) data reception should be active (where the data transmission/EH and the data reception alternate). The base station, e.g., via DCI transmitted to the EH device, may activate a first SPS configuration with a period of 200 ms and an associated capability indicator of {101} and may activate a second SPS configuration with the same period of 200 ms and an associated capability indicator of {010}. By indicating a time-offset (K0) of 50 ms for the first SPS configuration and a time-offset (K0) of 150 ms for the second SPS configuration, the base station may configure a combined communication and EH session that alternates between (1) data transmission and EH (e.g., associated with capability indicator {101}) and (2) data reception (e.g., associated with capability indicator {010}) every 100 ms.

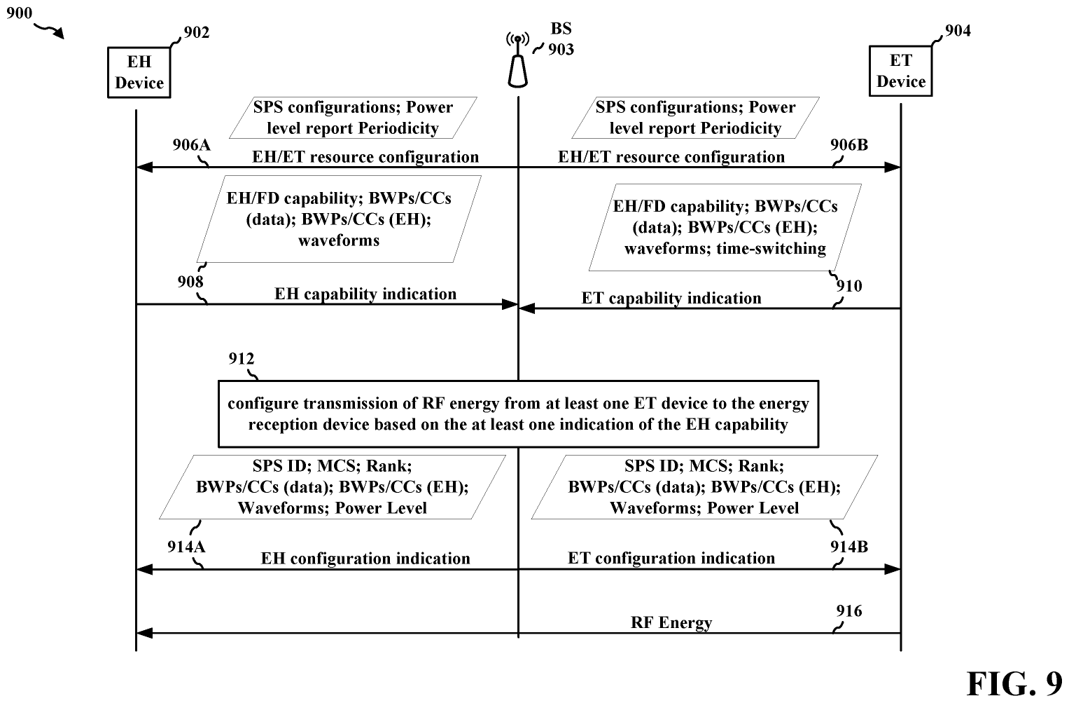

FIG. 9 is a call flow diagram 900 illustrating an EH device 902 (e.g., an EH-capable UE, a CPE, a wearable device, an IoT device, etc.) negotiating an EH operation with an ET device 904 (e.g., a UE, a CPE, a base station, a wearable device, an IoT device, an IAB node, a small cell, a pico cell, a micro cell, etc.) via a base station 903. The base station 903 may transmit, and the EH device 902 and the ET device 904 may receive, EH/ET resource configuration 906A/906B. The EH/ET resource configuration 906A/906B may include sets of resource-and-capability configurations (e.g., sets of SPS configurations 840) that can be subsequently activated. In some aspects, the EH/ET resource configuration 906A/906B may be transmitted via RRC signaling.

The EH device 902 may transmit, and the base station 903 may receive, an EH capability indication 908. The EH capability indication 908 may include an indication of a capability related to EH and/or a capability related to FD operation. In some aspects, the capabilities related to EH and FD operation are indicated for a set of bandwidth parts (BWPs) or component carriers (CCs). For example, an EH device 902 may indicate that for a first set of BWPs (or CCs) the EH device 902 is capable of FD operation, for a second set of BWPs (or CCs) the EH device 902 is capable of EH and FD operations (e.g., transmitting data, receiving data and harvesting energy simultaneously), and for a third set of BWPs (or CCs) the EH device 902 is capable of EH operations and data transmission in a same slot or symbol (e.g., simultaneously). In some aspects, the indication may include a number of BWPs or CCs that an EH device 902 can support when using different capabilities. For example, an EH device may support a first number “N” of CCs when transmitting and/or receiving data, a second number “M” of CCs when harvesting energy (e.g., a number of carriers that the UE supports for EH operation information and an (accumulated) EH operation across multiple carriers simultaneously), and a third number “L” of CCs when transmitting and/or receiving data as well as harvesting energy.

The capability indication 908 may also indicate a set of waveforms supported for EH, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission. The indication 908 may also be received by a set of ET devices (e.g., ET device 904 and additional ET devices). Transmitting the EH capability indication 908 may include transmitting an indication of a requested charging rate. The capability indication may enable the ET device 904 to transmit a power transfer waveform that corresponds to the waveform indicated by the EH device 902. In some aspects, the capability indication 908 may enable the EH device, or a base station 903, to select between multiple candidate ET devices.

The ET device 904 may transmit, and base station 903 may receive, an ET capability indication 910. The ET capability indication 910 may include an indication of a set of BWPs or CCs for which ET is supported. In some aspects, the indication may include a number of BWPs or CCs that an ET device can support. The BWPs or CCs for which ET is supported may be different than BWPs or CCs for which the ET device 904 supports data communication. The capability indication 910 may also indicate a set of waveforms supported for ET, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received.

Additionally, in some aspects, the indication 910 may indicate an ability to switch between supported waveforms (e.g., a transition time) or a timing of a reference ET signal for each supported waveform. The reference ET signal for a supported waveform may be used, e.g., by a base station 903 or EH device 902, to determine a reception power (e.g., measured by a reference signal received power (RSRP)). Measured power may be used to determine the efficiency associated with each supported waveform. The efficiency determination based on the reference signal may be used to determine a set of waveforms used for an EH/ET operation between an EH device and an ET device. For example, supported waveforms with an efficiency above an efficiency threshold may be used to transmit and receive energy while waveforms with an efficiency below the threshold may not be used to transmit and receive energy. The ET capability indication 910 may also be received by a set of EH devices (e.g., EH device 902 and additional EH devices). The ET capability indication 910, in some aspects, may include an indication of a set of frequencies (e.g., BWPs or CCs) supported for data transmission. The ET capability indication 910 may also include an ET power report indicating a current availability to serve as an ET node based on a power level of the ET device.

The base station 903, based on the EH capability indication 908 and the ET capability indication 910, may configure 912 transmission of RF energy from at least the ET device 904 (and possibly additional ET devices based on ET capability indications transmitted by the additional ET devices) to the energy reception device. For example, the base station 903 may determine a set of configuration parameters (e.g., BWPs, CCs, waveforms, resources (SPS configurations), a charging rate, etc.) for EH/ET that are supported by both the ET device 904 and the EH device 902. After determining the set of configuration parameters for the EH device 902, the base station 903 may transmit, and the EH device 902 may receive, an EH configuration indication 914A. Similarly, the base station 903 may transmit, and the ET device 904 may receive, an ET configuration indication 914B. The EH configuration indication 914A and the ET configuration indication 914B may include an indication of a set of time-and-frequency resources (e.g., BWPs, CCs, SPS configurations, etc.) for the EH/ET operation, and a set of capabilities, a set of waveforms, and a transmission/reception power associated with the different time-and-frequency resources. The transmission/reception power may be determined based on a requested reception power and a known attenuation of signal transmitted from the ET device 904 to the EH device 902. The indication may include one or more identifiers associated with one or more resource-and-capability configurations in the set of EH/ET resource configurations 906A/906B. Additional parameters relating to the SPS occasions of an activated SPS configuration such as an MCS, an RB allocation (to identify a set of frequency resources during the reception occasions), antenna ports, etc. may be indicated in configuration indications 914A and/or 914B. Based on the EH configuration indication 914A and the ET configuration indication 914B, the ET device 904 may transmit, and the EH device 902 may receive, RF energy 916.

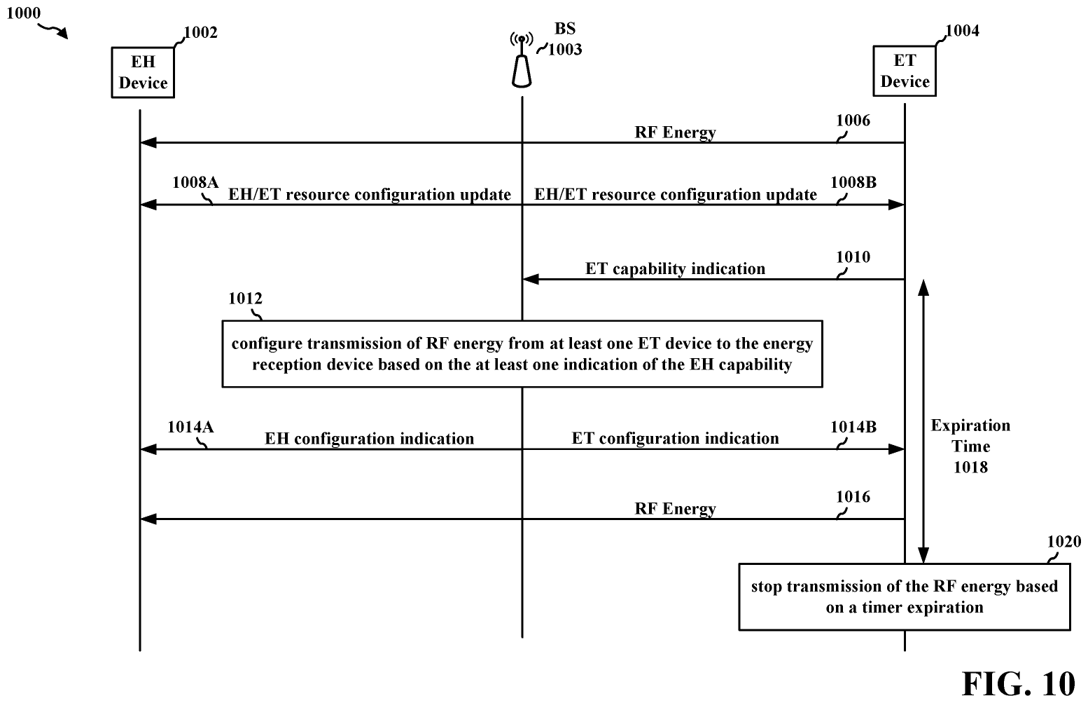

FIG. 10 is a call flow diagram 1000 illustrating an EH device 1002 (e.g., an EH-capable UE, a CPE, a wearable device, an IoT device, etc.) engaging in an EH operation with an ET device 1004 (e.g., a UE, a CPE, a base station, a wearable device, an IoT device, etc.) that is updated via a base station 1003. An ET device 1004 may transmit, and EH device 1002 may receive, RF energy 1006 as described in relation to the ET device 904 transmitting, and the EH device 902 receiving, RF energy 916 of FIG. 9. The base station 1003 may transmit, and the EH device 1002 and the ET device 1004 may receive, EH/ET resource configuration update 1008A/1008B. The EH/ET resource configuration update 1008A/1008B may include at least one update to the sets of resource-and-capability configurations (e.g., sets of SPS configurations 840). For example, the update may add an EH or ET resource-and-capability configuration to the set of EH and/or ET resource-and-capability configurations. Alternatively, or additionally, the update may remove an EH or ET resource-and-capability configuration to the set of EH and/or ET resource-and-capability configurations. In some aspects, the update may modify an existing EH or ET resource-and-capability configuration (e.g., modify a capability indicator, a set of SPS parameters, associated criteria/policies, etc.) in the set of EH and/or ET resource-and-capability configurations. In some aspects, the EH/ET resource configuration update 1008A/1008B may be transmitted via a MAC-CE.

The ET device 1004 may transmit, and base station 1003 may receive, an ET capability indication 1010 indicating a current ability of the ET device 1004 to serve as an ET node based on a power level associated with the ET device (e.g., a battery level, a powered state in which the ET device is connected to an external power source, etc.). The ET capability indication 1010 may be a periodically transmitted power level report based on a period configured by the base station 1003 via RRC signaling. In some aspects, the periodicity of the power level report 1010 is further associated with an expiration timer after which an ET device 1004 that fails to provide a power level report to the base station 1003 may stop any current ET operations.

Based on the ET capability indication 1010, the base station may configure 1012 transmission of RF energy from at least the ET device 1004 (and possibly additional ET devices based on ET capability indications transmitted by the additional ET devices) to the EH device 1002 (and possibly additional EH devices). For example, the base station 1003 may determine a set of configuration parameters (e.g., BWPs, CCs, waveforms, resources (SPS configurations), a charging rate, etc.) for EH/ET that are supported by both the ET device 1004 and the EH device 1002 based on the ET capability indication (e.g., the power level report) 1010. After determining the set of configuration parameters for the EH device 1002, the base station 1003 may transmit, and the EH device 1002 may receive, an EH configuration indication 1014A. Similarly, the base station 1003 may transmit, and the ET device 1004 may receive, an ET configuration indication 1014B. EH configuration indication 1014A and ET configuration indication 1014B may include an indication of a set of time-and-frequency resources (e.g., BWPs, CCs, SPS configurations, etc.) for the EH/ET operation, and a set of capabilities, a set of waveforms, and a transmission/reception power associated with the different time-and-frequency resources. Based on the EH configuration indication 1014A and the ET configuration 1014B, the ET device 1004 may transmit, and the EH device 1002 may receive, RF energy 1016.

If the ET device 1004 does not transmit an additional ET capability indication (or power level report) for an interval lasting an expiration time 1018, the ET device may stop 1020 transmission of RF energy based on the passing of the expiration time 1018. Additionally, the base station 1003, may determine 1022, based on the passing of the expiration time 1018, that the ET device 1004 does not support ET. In some aspects, an additional ET capability indication (or power level report) may indicate a particular power level and the base station 1003 may determine whether the indicated particular power level is above a power level threshold such that the ET device 1004 supports ET operations, or below the threshold power level such that the ET device 1004 does not support ET operations.

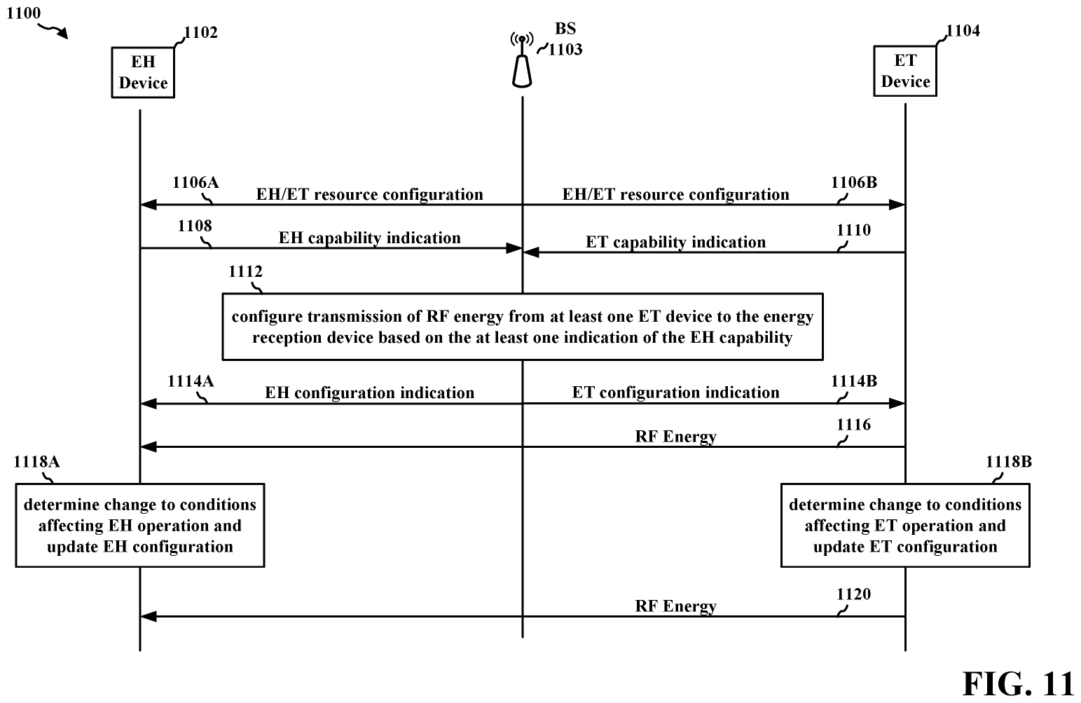

FIG. 11 is a call flow diagram 1100 illustrating an EH device 1102 (e.g., an EH-capable UE, a CPE, a wearable device, an IoT device, etc.) negotiating an EH operation with an ET device 1104 (e.g., a UE, a CPE, a base station, a wearable device, an IoT device, etc.) via a base station 1103. The base station 1103 may transmit, and the EH device 1102 and the ET device 1104 may receive, EH/ET resource configuration 1106A/1106B. The EH/ET resource configuration 1106A/1106B may include sets of resource-and-capability configurations (e.g., sets of SPS configurations 840) that can be subsequently activated. In some aspects, the EH/ET resource configuration 1106A/1106B may be transmitted via RRC signaling. An SPS configuration may be associated with a particular application, traffic type (e.g., URLLC, eMBB, high-QoS traffic, or low-QoS traffic, etc.), a traffic density, an error rate (e.g., a BLER or SNR), or a threshold number of ACK/NACK within a period of time, by a policy or criteria (e.g., policy or criteria 858A/858N of FIG. 8).

The EH device 1102 may transmit, and the base station 1103 may receive, an EH capability indication 1108. The EH capability indication 1108 may include an indication of a capability related to EH and/or a capability related to FD operation. In some aspects, the capabilities related to EH and FD operation are indicated for a set of BWPs or component carriers (CCs). For example, an EH device 1102 may indicate that for a first set of BWPs (or CCs) the EH device is capable of FD operation, for a second set of BWPs (or CCs) the EH device is capable of EH and FD operations, and for a third set of BWPs (or CCs) the EH device is capable of EH operations and data transmission. In some aspects, the indication may include a number of BWPs or CCs that an EH device can support when using different capabilities. For example, an EH device may support a first number “N” of CCs when transmitting and/or receiving data, a second number “M” of CCs when harvesting energy, and a third number “L” of CCs when transmitting and/or receiving data as well as harvesting energy.

The capability indication 1108 may also indicate a set of waveforms supported for EH, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission. The indication 1108 may also be received by a set of ET devices (e.g., ET device 1104 and additional ET devices). Transmitting the EH capability indication 1108 may include transmitting an indication of a requested charging rate.

The ET device 1104 may transmit, and base station 1103 may receive, an ET capability indication 1110. The ET capability indication 1110 may include an indication of a set of BWPs or CCs for which ET is supported. In some aspects, the indication may include a number of BWPs or CCs that an ET device can support. The capability indication 1110 may also indicate a set of waveforms supported for ET, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received.

Additionally, in some aspects, the indication 1110 may indicate an ability to switch between supported waveforms (e.g., a transition time) or a timing of a reference ET signal for each supported waveform. The reference ET signal for a supported waveform may be used to determine the efficiency of the supported waveform. The efficiency determination based on the reference signal may be used to determine a set of waveforms used for an EH/ET operation between an EH device and an ET device. The ET capability indication 1110 may also be received by a set of EH devices (e.g., EH device 1102 and additional EH devices). The ET capability indication 1110, in some aspects, may include an indication of a set of frequencies (e.g., BWPs or CCs) supported for data transmission. The ET capability indication 1110 may also include an ET power report indicating a current availability to serve as an ET node based on a power level of the ET device.

The base station 1103, based on the EH capability indication 1108 and the ET capability indication 1110, may configure 1112 transmission of RF energy from at least the ET device 1104 (and possibly additional ET devices based on ET capability indications transmitted by the additional ET devices, etc.) to the energy reception device. For example, the base station 1103 may determine a set of configuration parameters (e.g., BWPs, CCs, waveforms, resources (SPS configurations), a charging rate, etc.) for EH/ET that are supported by both the ET device 1104 and the EH device 1102. After determining the set of configuration parameters for the EH device 1102, the base station 1103 may transmit, and the EH device 1102 may receive, an EH configuration indication 1114A. Similarly, the base station 1103 may transmit, and the ET device 1104 may receive, an ET configuration indication 1114B. EH configuration indication 1114A and ET configuration indication 1114B may include an indication of a set of time-and-frequency resources (e.g., BWPs, CCs, SPS configurations, etc.) for the EH/ET operation, and a set of capabilities, a set of waveforms, and a transmission/reception power associated with the different time-and-frequency resources. Based on the EH configuration indication 1114A and the ET configuration 1114B, the ET device 1104 may transmit, and the EH device 1102 may receive, RF energy 1116.

During an EH/ET operation, the EH device 1102 and the ET device 1104 may determine 1118A/1118B a change to conditions (e.g., a change to a traffic density, a change to a BLER, a change to a traffic type) affecting an EH/ET operation and update the EH/ET operation (e.g., apply a different resource configuration) based on the criteria or policies included in the set of configurations. The ET device 1104 may then transmit, and EH device 1102 may receive, RF energy 1120 based on the updated criteria. The different configuration may be applied based on a timing trigger that is configured (e.g., via RRC) or signaled (e.g., via SCI or other SL communication).

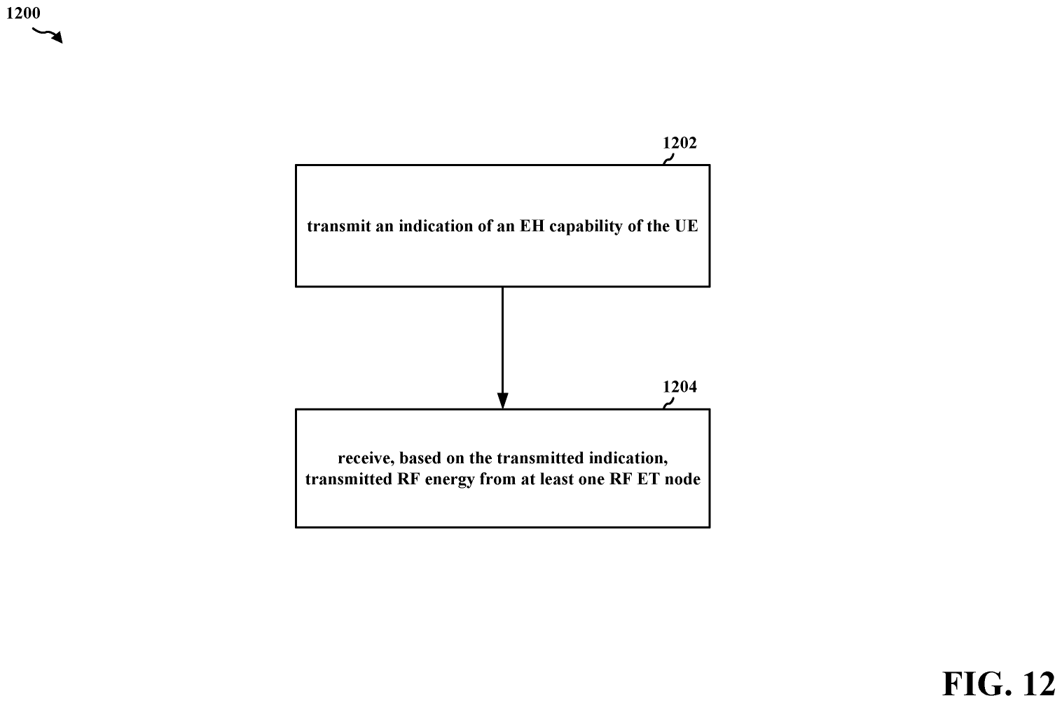

FIG. 12 is a flowchart 1200 of a method of wireless communication. The method may be performed by an EH device (e.g., the UE 104/610-616; the EH device 902/1002/1102; the apparatus 1802). At 1202, the EH device may transmit an EH capability indication. The EH capability indication may include an indication of a capability related to EH and/or a capability related to FD operation. In some aspects, the capabilities related to EH and FD operation are indicated for a set of BWPs or CCs. For example, an EH device may indicate that for a first set of BWPs (or CCs) the EH device is capable of FD operation, for a second set of BWPs (or CCs) the EH device is capable of EH and FD operations, and for a third set of BWPs (or CCs) the EH device is capable of EH operations and data transmission. In some aspects, the indication may include a number of BWPs or CCs that an EH device can support when using different capabilities. For example, an EH device may support a first number “N” of CCs when transmitting and/or receiving data, a second number “M” of CCs when harvesting energy, and a third number “L” of CCs when transmitting and/or receiving data as well as harvesting energy.

The capability indication may also indicate a set of waveforms supported for EH, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission. For example, referring to FIGS. 9 and 11, an EH device 902/1102 may transmit EH capability indication 908/1108. For example, 1202 may be performed by an RF EH indication component 1840.

At 1204, the EH device may receive, based on the transmitted indication, transmitted RF energy from at least one RF ET node. The transmitted RF energy may be received based on a set of capabilities shared by the EH device and at least one RF ET node transmitting the RF energy. For example, referring to FIGS. 9 and 11, an EH device 902/1102 may receive RF energy 916/1120. For example, 1204 may be performed by an RF EH component 1844.

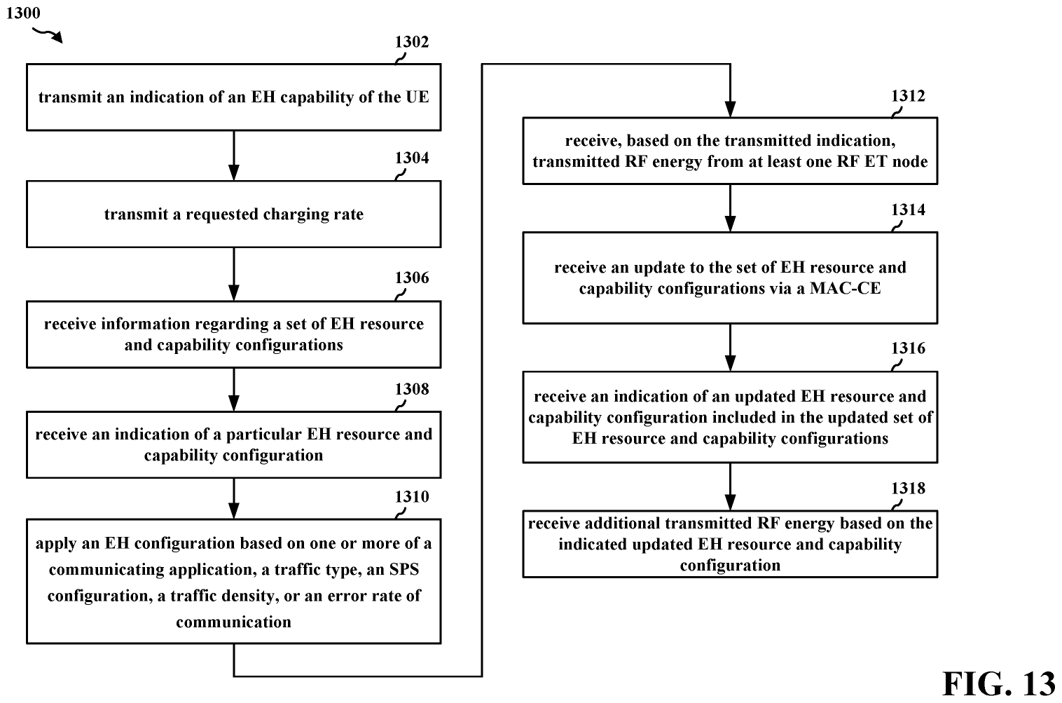

FIG. 13 is a flowchart 1300 of a method of wireless communication. The method may be performed by an EH device (e.g., the UE 104/610-616; the EH device 902/1002/1102; the apparatus 1802). At 1302, the EH device may transmit an EH capability indication. The EH capability indication may include an indication of a capability related to EH and/or a capability related to FD operation. In some aspects, the capabilities related to EH and FD operation are indicated for a set of BWPs or CCs. For example, an EH device may indicate that for a first set of BWPs (or CCs) the EH device is capable of FD operation, for a second set of BWPs (or CCs) the EH device is capable of EH and FD operations, and for a third set of BWPs (or CCs) the EH device is capable of EH operations and data transmission. In some aspects, the indication may include a number of BWPs or CCs that an EH device can support when using different capabilities. For example, an EH device may support a first number “N” of CCs when transmitting and/or receiving data, a second number “M” of CCs when harvesting energy, and a third number “L” of CCs when transmitting and/or receiving data as well as harvesting energy.

The capability indication may also indicate a set of waveforms supported for EH, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission. At 1304, the EH device may transmit a requested charging power. In some aspects, the requested charging power is included in the indication of the EH capability transmitted at 1302. For example, referring to FIGS. 9 and 11, an EH device 902/1102 may transmit EH capability indication 908/1108 (including a requested charging power or charging rate). The requested charging power, in some aspects, is a requested (charging) power to be received at the EH device 902/1102 that is used to determine, at an ET device 904/1104, a transmission power. In other aspects, the requested charging power may be a transmission (charging) power from the ET device. The transmission power may be calculated (either by the EH device or the ET device) based on a received signal power (e.g., a measured RSRP at the EH device that, for an ET device-determined transmission power, is indicated to the ET device) and a transmission power (e.g., a configured or indicated power). For example, 1302 and 1304 may be performed by an RF EH indication component 1840.

At 1306, the EH device may receive an EH resource configuration. The EH resource configuration may include sets of resource-and-capability configurations (e.g., sets of SPS configurations 840) that can be subsequently activated. The sets of resource-and-capability configurations may also include a set of criteria (e.g., a particular application, traffic type (e.g., URLLC, eMBB, high-QoS traffic, or low-QoS traffic, etc.), a traffic density, or a BLER) for applying one or more of the resource-and-capability configurations for an EH operation. In some aspects, the EH resource configuration may be transmitted via RRC signaling. For example, referring to FIGS. 8 and 9, an EH device 902 may receive EH resource configuration 906A including a set of SPS resource configurations 840. For example, 1306 may be performed by RF EH configuration component 1842.

At 1308, the EH device may receive an EH configuration indication. The EH configuration indication may include an indication of a particular EH resource-and-capability configuration in the EH resource configuration. The indicated particular EH resource-and-capability configuration may indicate or include a set of time-and-frequency resources (e.g., BWPs, CCs, SPS configurations, etc.) for the EH operation, and a set of capabilities, a set of waveforms, and a transmission/reception power associated with different time-and-frequency resources in the set of time-and-frequency resources. The set of time-and-frequency resources and capabilities may be indicated by indicating (e.g., via DCI) a resource configuration in the EH resource configuration received at 1306. For example, referring to FIGS. 8 and 9, the EH device 902 may receive the EH configuration indication 914A that may include an indication of a set of time-and-frequency resources (e.g., BWPs, CCs, SPS configurations, etc.) for the EH/ET operation, and a set of capabilities, a set of waveforms, and a transmission/reception power associated with the different time-and-frequency resources. The set of time-and-frequency resources and a set of capabilities associated with the set of time-and-frequency resources may be indicated by indicating an SPS configuration included in the EH resource configuration 906A. For example, 1308 may be performed by RF EH configuration component 1842.

At 1310, the EH device may apply an EH configuration for receiving RF energy based on one or more of a communicating application of the EH device, a traffic type, an SPS configuration, a traffic density associated with the EH device, or an error rate of communication at the EH device. The EH device may apply a particular EH configuration based on a priority associated with the communication and/or the EH operation and a set of policies/criteria indicated in the EH resource configuration received at 1306. For example, a particular set of resource configurations (e.g., SPS 1 or SPS 2 of FIG. 8) may be indicated for high-priority traffic (e.g., URLLC or high-QoS traffic) and, based on a set of criteria, the EH device may determine to use a particular resource configuration associated with a capability indicator (e.g., {010}) indicating that the particular time-and-frequency resources associated with the particular resource configuration may be used to receive data, but not to transmit data or receive energy to limit interference with the data reception. For lower priority traffic (e.g., eMBB), the EH device may apply a different resource configuration associated with a capability indicator (e.g., {111}) indicating that the particular time-and-frequency resources associated with the different resource configuration may be used to transmit data, receive data, and receive energy.

Additionally, in some aspects, the EH may determine that a characteristic associated with a policy or criteria has changed and identify a new resource configuration associated with the changed characteristic of the traffic and/or EH operation. The new resource configuration may be applied at a particular time after a change has been identified that is configured (e.g., by a base station via RRC) or negotiated between the EH device and the ET device. For example, referring to FIG. 11, the EH device 1102 may detect 1118A a change to conditions (e.g., a change to a traffic density, a change to a BLER, a change to a traffic type) affecting an EH/ET operation and apply a different resource configuration to the EH/ET operation based on the criteria or policies included in the set of resource configurations. For example, 1310 may be performed by RF EH configuration component 1842.

At 1312, the EH device may receive, based on the transmitted indication, transmitted RF energy from at least one RF ET node. The transmitted RF energy may be received based on a set of capabilities shared by the EH device and at least one RF ET node transmitting the RF energy. For example, referring to FIGS. 9 and 11, an EH device 902/1102 may receive RF energy 916/1120. For example, 1312 may be performed by an RF EH component 1844.

At 1314, the EH device may receive an update to the set of EH resource-and-capability configurations. The update to the set of EH resource-and-capability configurations may be received via a MAC-CE. The EH resource configuration update may include at least one update to the sets of resource-and-capability configurations received at 1306. For example, referring to FIGS. 8 and 10, the EH device 1002 may receive EH resource configuration update 1008A that may include at least one update to the sets of resource-and-capability configurations (e.g., sets of SPS configurations 840). For example, 1314 may be performed by an RF EH configuration component 1842.

At 1316, the EH device may receive an indication of an updated EH resource-and-capability configuration included in the updated set of EH resource-and-capability configurations. The EH configuration indication may include an indication of a particular EH resource-and-capability configuration in the updated EH resource configuration. The indicated particular EH resource-and-capability configuration may indicate or include a set of time-and-frequency resources (e.g., BWPs, CCs, SPS configurations, etc.) for the EH operation, and a set of capabilities, a set of waveforms, and a transmission/reception power associated with different time-and-frequency resources in the set of time-and-frequency resources. The set of time-and-frequency resources and capabilities may be indicated by indicating (e.g., via DCI) a resource configuration in the EH resource configuration received at 1306 and updated at 1314. For example, referring to FIG. 10, an EH device may receive an EH configuration indication 1014A that identifies at least one resource-and-capability configuration in the set of updated resource-and-capability configurations. The EH configuration indication 1014A may include an indication of a set of time-and-frequency resources (e.g., BWPs, CCs, SPS configurations, etc.) for the EH operation, and a set of capabilities, a set of waveforms, and a transmission/reception power associated with the different time-and-frequency resources. For example, 1314 may be performed by an RF EH configuration component 1842.

Finally, at 1318, the EH device may receive additional transmitted RF energy based on the indicated updated EH resource-and-capability configuration. The transmitted RF energy may be received based on a set of capabilities shared by the EH device and at least one RF ET node transmitting the RF energy. For example, referring to FIG. 10, an EH device 1002 may receive RF energy 1016. For example, 1318 may be performed by an RF EH component 1844.

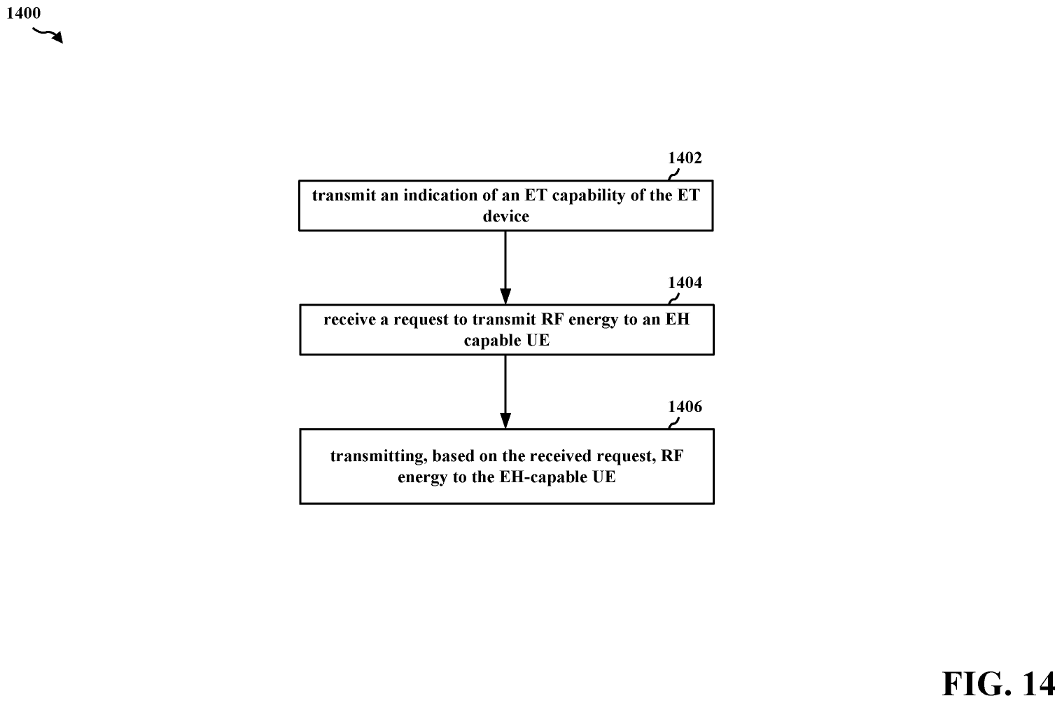

FIG. 14 is a flowchart 1400 of a method of wireless communication. The method may be performed by an ET device (e.g., the UE 104/610-616; the ET device 904/1004/1104; the apparatus 1902). At 1402, the ET device may transmit an ET capability indication. The ET capability indication may include an indication of a set of BWPs or CCs for which ET is supported. In some aspects, the ET capability indication may include a number of BWPs or CCs that an ET device can support. The ET capability indication may also indicate a set of waveforms supported for ET, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission.

Additionally, in some aspects, the indication may indicate an ability to switch between supported waveforms (e.g., a transition time) or a timing of a reference ET signal for each supported waveform. The indication may also include an indication of a transmission power characteristic, e.g., a transmission power associated with the reference ET signal, a set of possible transmission powers, and/or a maximum transmission power. The reference ET signal for a supported waveform may be used to determine the efficiency of the supported waveform (e.g., based on an indicated transmission power and a measured reception power). The efficiency determination based on the reference signal may be used to determine a set of waveforms used for an EH/ET operation between an EH device and the ET device.

The ET capability indication, in some aspects, may include an indication of a set of frequencies (e.g., BWPs or CCs) supported for data transmission. The indication may include a set of supported waveforms, the ability to switch between waveforms, and/or a transmission power characteristic for each supported set of frequencies (e.g., BWP or CC). The ET capability indication may also include an ET power report indicating a current availability to serve as an ET node based on a power level of the ET device. For example, referring to FIGS. 9-11, the ET device 904/1004/1104 may transmit ET capability indication 910/1010/1110. For example, 1402 may be performed by RF ET indication component 1940.

At 1404, the ET device may receive a request to transmit RF energy to an EH-capable device (e.g., a UE, a wearable device, an IoT device, etc.). The request to transmit RF energy, in some aspects, is an ET configuration indication received from a base station. In some aspects, the request is included in an EH capability indication and indicates one or more of a requested duration of an EH operation, a requested charging rate (for each supported BWP or CC), and a supported EH architecture (e.g., separated receiver, time-switching, or power-splitting) along with the other elements of the EH capability indication discussed above in relation to the EH capability indication of FIGS. 9-13. The ET configuration indication (e.g., the request to transmit RF energy to the EH-capable device) may include an indication of a set of time-and-frequency resources (e.g., BWPs, CCs, SPS configurations, etc.) for the ET operation, and a set of capabilities, a set of waveforms, and a transmission/reception power associated with the different time-and-frequency resources. For example, referring to FIGS. 9-11, the EH device 904/1004/1104 may receive ET configuration indication 914B/1014B/1114B including a request, an indication, or a configuration for the ET device 904/1004/1104 to transmit RF energy 916/1016/1116 to EH device 902/1002/1102. For example, 1404 may be performed by RF ET configuration component 1942.

Finally, at 1406, the ET device may transmit, based on the request to transmit RF energy to the EH-capable device, RF energy to the EH-capable device. ET waveforms, when not used for transmitting data, may be generated by pseudo-random generators. For example, referring to FIGS. 9-11, the EH device 904/1004/1104 may transmit RF energy 916/1016/1116 to EH device 902/1002/1102. For example, 1406 may be performed by RF ET component 1944.

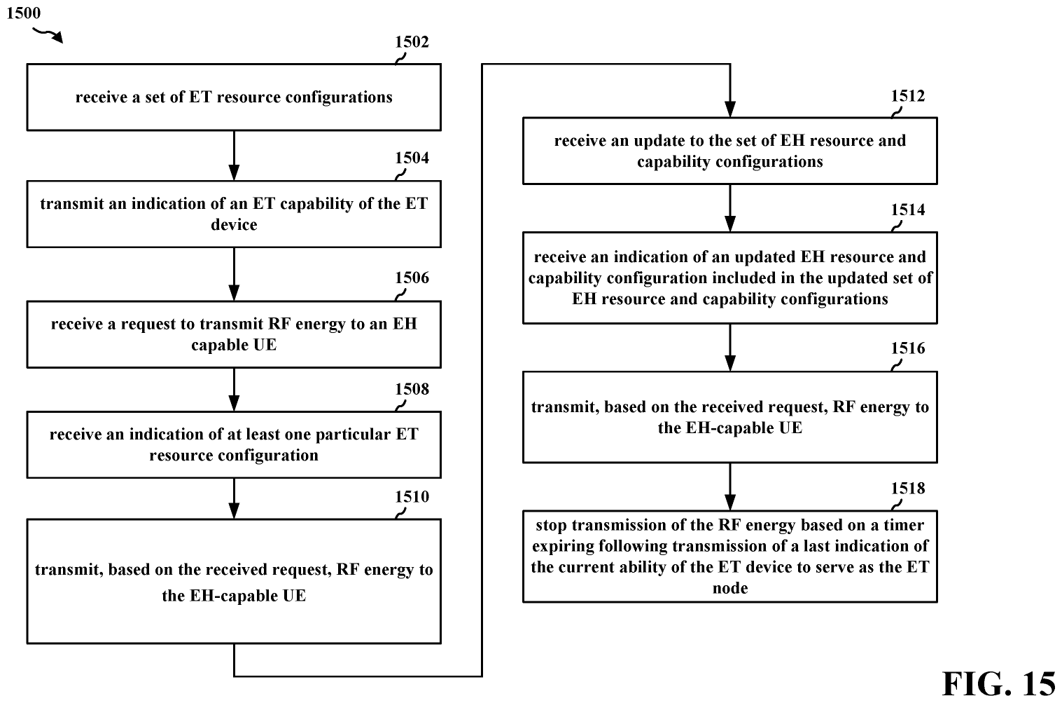

FIG. 15 is a flowchart 1500 of a method of wireless communication. The method may be performed by an ET device (e.g., the UE 104/610-616; the ET device 904/1004/1104; the apparatus 1902). At 1502, The ET device may receive a set of ET resource (and capability) configurations. The ET resource configuration may include sets of resource-and-capability configurations (e.g., sets of SPS configurations 840 of FIG. 8) that can be subsequently activated. In some aspects, the ET resource configuration may be transmitted via RRC signaling. For example, referring to FIGS. 9 and 11, the ET device 904/1104 may receive the ET resource configuration 906B/1106B. For example, 1502 may be performed by RF ET configuration component 1942.

At 1504, the ET device may transmit an ET capability indication. The ET capability indication may include an indication of a set of BWPs or CCs for which ET is supported. In some aspects, the ET capability indication may include a number of BWPs or CCs that an ET device can support. The ET capability indication may also indicate a set of waveforms supported for ET, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission.

Additionally, in some aspects, the indication may indicate an ability to switch between supported waveforms (e.g., a transition time) or a timing of a reference ET signal for each supported waveform. The reference ET signal for a supported waveform may be used to determine the efficiency of the supported waveform. The efficiency determination based on the reference signal may be used to determine a set of waveforms used for an EH/ET operation between an EH device and the ET device. The ET capability indication, in some aspects, may include an indication of a set of frequencies (e.g., BWPs or CCs) supported for data transmission. The ET capability indication may also include an ET power report indicating a current availability to serve as an ET node based on a power level of the ET device. For example, referring to FIGS. 9-11, the ET device 904/1004/1104 may transmit ET capability indication 910/1010/1110. For example, 1504 may be performed by RF ET indication component 1940.

At 1506, the ET device may receive a request to transmit RF energy to an EH-capable device (e.g., a UE, a wearable device, an IoT device, etc.). In some aspects, the request is included in an EH capability indication and indicates one or more of a requested duration of an EH operation, a requested charging rate (for each supported BWP or CC), and a supported EH architecture (e.g., separated receiver, time-switching, or power-splitting) along with the other elements of the EH capability indication discussed above in relation to the EH capability indication of FIGS. 9-13. The ET configuration indication (e.g., the request to transmit RF energy to the EH-capable device) may include an indication of a set of time-and-frequency resources (e.g., BWPs, CCs, SPS configurations, etc.) for the ET operation, and a set of capabilities, a set of waveforms, and a transmission/reception power associated with the different time-and-frequency resources. For example, referring to FIGS. 9-11, the ET device 904/1004/1104 may receive ET configuration indication 914B/1014B/1114B including a request, an indication, or a configuration for the ET device 904/1004/1104 to transmit RF energy 916/1016/1116 to EH device 902/1002/1102. For example, 1506 may be performed by RF ET configuration component 1942.

The ET device, at 1508, may receive an indication of at least one particular ET resource configuration for transmitting RF energy to the EH-capable device. The ET configuration indication may include an indication of a set of time-and-frequency resources (e.g., BWPs, CCs, SPS configurations, etc.) for the ET operation, and a set of capabilities, a set of waveforms, and a transmission/reception power associated with the different time-and-frequency resources. The indication may include an indication of a particular set of resource-and-capability configurations in the set of ET resource-and-capability configurations received at 1502. For example, referring to FIGS. 9-11, the ET device 904/1004/1104 may receive an ET configuration indication 914B/1014B/1114B indicating a configuration to use for an RF ET operation. For example, 1508 may be performed by RF ET configuration component 1942.

At 1510, the ET device may transmit RF energy to the EH-capable device based on indication of at least one particular ET resource configuration for transmitting RF energy to the EH-capable device. ET waveforms, when not used for transmitting data, may be generated by pseudo-random generators. For example, referring to FIGS. 9-11, the EH device 904/1004/1104 may transmit RF energy 916/1016/1116 to EH device 902/1002/1102. For example, 1510 may be performed by RF ET component 1944.

At 1512, the ET device may receive an ET resource configuration update. The ET resource configuration update may include at least one update to the sets of resource-and-capability configurations received at 1502 (e.g., sets of SPS configurations 840 of FIG. 8). In some aspects, the ET resource configuration update may be transmitted via a MAC-CE. For example, referring to FIGS. 8 and 10, the ET device 1004 may receive ET resource configuration update 1008B that may include at least one update to the sets of resource-and-capability configurations (e.g., sets of SPS configurations 840). For example, 1512 may be performed by an RF ET configuration component 1942.

At 1514, the ET device may receive an indication of an updated ET resource-and-capability configuration included in the updated set of ET resource-and-capability configurations. The ET configuration indication may include an indication of a particular ET resource-and-capability configuration in the updated ET resource configuration. The indicated particular ET resource-and-capability configuration may indicate or include a set of time-and-frequency resources (e.g., BWPs, CCs, SPS configurations, etc.) for the ET operation, and a set of capabilities, a set of waveforms, and a transmission/reception power associated with different time-and-frequency resources in the set of time-and-frequency resources. The set of time-and-frequency resources and capabilities may be indicated by indicating (e.g., via DCI) a resource configuration in the ET resource configuration received at 1502 and updated at 1512. For example, referring to FIG. 10, an ET device may receive an ET configuration indication 1014B that identifies at least one resource-and-capability configuration in the set of updated ET resource-and-capability configurations. The ET configuration indication 1014B may include an indication of a set of time-and-frequency resources (e.g., BWPs, CCs, SPS configurations, etc.) for the ET operation, and a set of capabilities, a set of waveforms, and a transmission/reception power associated with the different time-and-frequency resources. For example, 1514 may be performed by an RF ET configuration component 1942.

At 1516, the ET device may transmit RF energy based on the indication of an updated ET resource-and-capability configuration included in the updated set of ET resource-and-capability configurations received at 1514. For example, referring to FIG. 10, the EH device 1004 may transmit RF energy 1016 to EH device 1002 based on the ET configuration 1014B. For example, 1516 may be performed by RF ET component 1944.

Finally, at 1518, the ET device may stop transmitting RF energy based on a timer expiring following transmission of a last indication of the current ability of the ET device to serve as the ET node (and before the transmission of a next of the indication of the current ability of the ET device to serve as the ET node). An expiration time may be configured by a base station via RRC signaling. For example, referring to FIG. 10, the ET device 1004 may stop 1020 transmitting RF energy 1016 based on a time greater than expiration time 1018 having passed since a last ET capability indication 1010 including indication of the current ability of the ET device to serve as the ET node. For example, 1518 may be performed by RF ET component 1944.

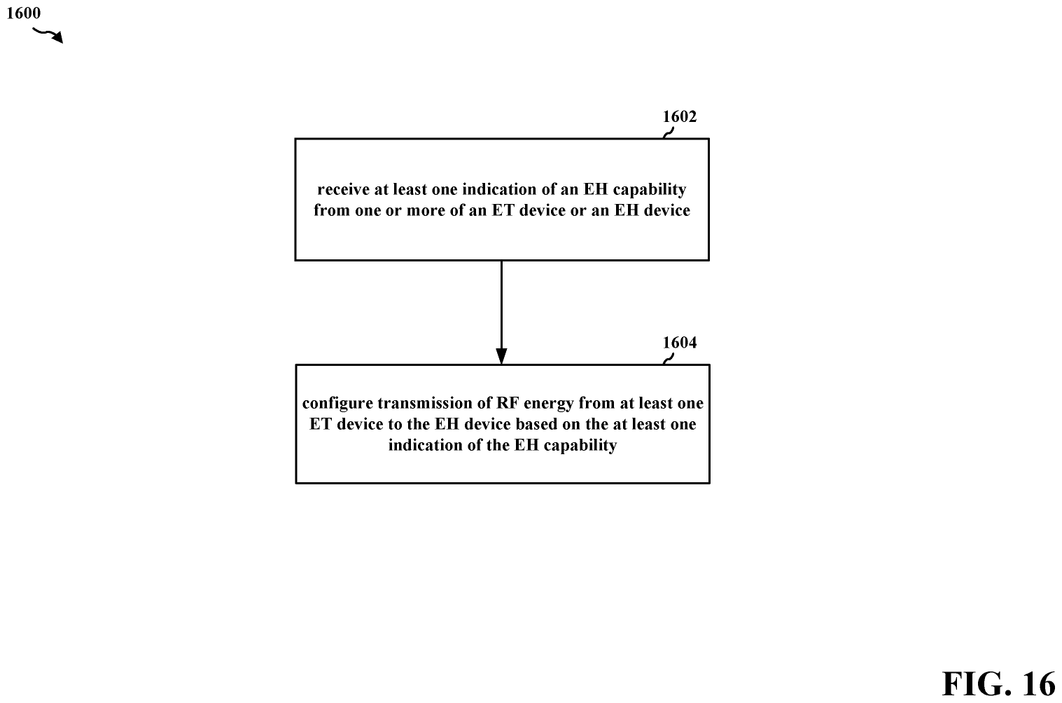

FIG. 16 is a flowchart 1600 of a method of wireless communication. The method may be performed by a base station (e.g., the base station 102/602/604; the base station 903/1003/1103; the apparatus 2002). At 1602, the base station may receive, at least one indication of an EH/ET capability from one or more of an ET device or an EH device. The EH capability indication may include an indication of a capability related to EH and/or a capability related to FD operation. In some aspects, the capabilities related to EH and FD operation are indicated for a set of BWPs or CCs. For example, an EH device may indicate that for a first set of BWPs (or CCs) the EH device is capable of FD operation, for a second set of BWPs (or CCs) the EH device is capable of EH and FD operations, and for a third set of BWPs (or CCs) the EH device is capable of EH operations and data transmission. In some aspects, the indication may include a number of BWPs or CCs that an EH device can support when using different capabilities. For example, an EH device may support a first number “N” of CCs when transmitting and/or receiving data, a second number “M” of CCs when harvesting energy, and a third number “L” of CCs when transmitting and/or receiving data as well as harvesting energy.

The EH capability indication may also indicate a set of waveforms supported for EH, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission. Receiving the EH capability indication may include receiving an indication of a requested charging rate.

The base station may receive, from an ET device, an ET capability indication. The ET capability indication may include an indication of a set of BWPs or CCs for which ET is supported. In some aspects, the indication may include a number of BWPs or CCs that an ET device can support. The capability indication may also indicate a set of waveforms supported for ET, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission.

Additionally, in some aspects, the ET capability indication may indicate an ability to switch between supported waveforms (e.g., a transition time) or a timing of a reference ET signal for each supported waveform. The reference ET signal for a supported waveform may be used to determine the efficiency of the supported waveform. The efficiency determination based on the reference signal may be used to determine a set of waveforms used for an EH/ET operation between an EH device and an ET device. The ET capability indication may also be received by a set of EH devices (e.g., EH device 902 and additional EH devices). The ET capability indication, in some aspects, may include an indication of a set of frequencies (e.g., BWPs or CCs) supported for data transmission. The ET capability indication may also include an ET power report indicating a current availability to serve as an ET node based on a power level of the ET device. For example, referring to FIGS. 9-11, the base station 903/1003/1103 may receive a capability indication 908/910/1010/1108/1110 from one or more of an ET device 904/1004/1104 or an EH device 902/1002/1102. For example, 1602, may be performed by RF ET indication component 2040.

At 1604, the base station may configure transmission of RF energy from at least one ET device to the energy reception device based on the at least one indication of the EH capability. For example, referring to FIG. 9, the base station 903 may determine a set of configuration parameters (e.g., BWPs, CCs, waveforms, resources (SPS configurations), a charging rate, etc.) for EH/ET that are supported by both the ET device 904 and the EH device 902 and transmit an EH configuration indication and/or an ET configuration indication to configure the EH/ET operation between the EH device 902 and the ET device 904. For example, 1604 may be performed by RF ET configuration component 2042.

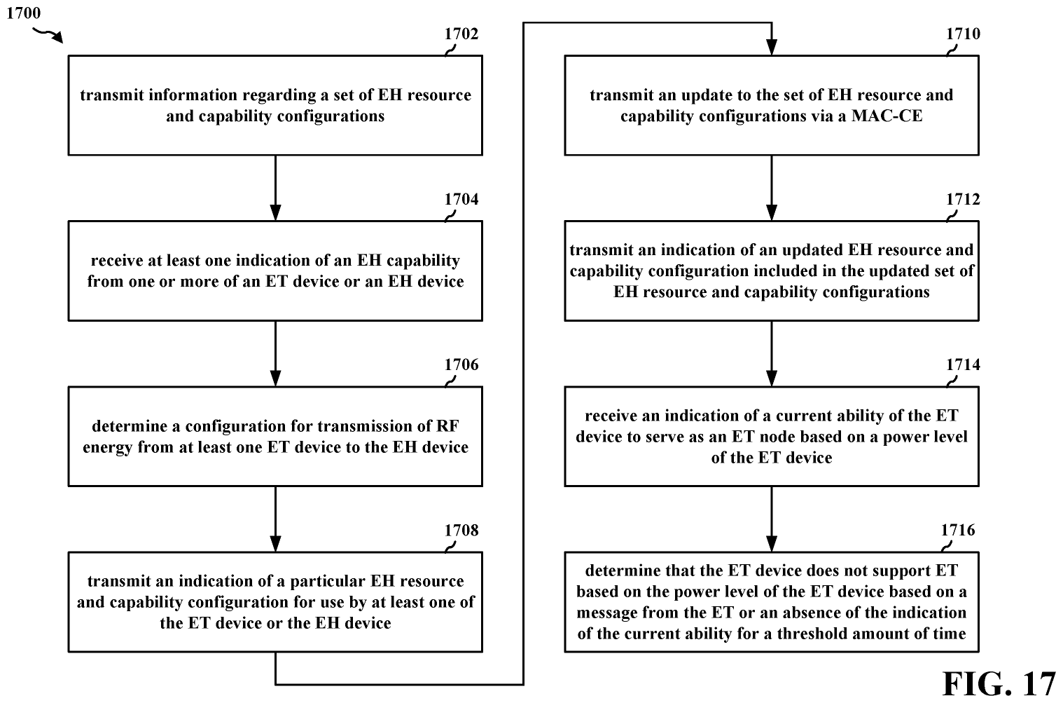

FIG. 17 is a flowchart 1700 of a method of wireless communication. The method may be performed by a base station (e.g., the base station 102/602/604; the base station 903/1003/1103; the apparatus 2002). At 1702, the base station may transmit information regarding a set of EH and/or ET resource-and-capability configurations. The EH and/or ET resource-and-capability configurations may include sets of resource-and-capability configurations (e.g., sets of SPS configurations 840 of FIG. 8) that can be subsequently activated. The sets of resource-and-capability configurations may include multiple subsets of SPS configurations. Each SPS configuration may include an identifier, a capability indicator, and a set of SPS parameters (e.g., including a period (P/P′) and a time-offset (K1/K1′) for transmitting ACK/NACK). An SPS configuration may be associated with a particular application, traffic type (e.g., URLLC, eMBB, high-QoS traffic, or low-QoS traffic, etc.), a traffic density, or an error rate (e.g., a BLER or SNR) by a policy or criteria. The SPS identifier may be used to identify a particular SPS configuration in the set of resource-and-capability configurations in a subsequent activation or modification operation, e.g., in DCI used to activate a configuration or in a MAC-CE that may be used to update a configuration. The capability indicator may be a value (e.g., an N-bit value) indicating whether each of a set of N capabilities is activated during each of the SPS PDSCH resources (and during the PUCCH grant).

The set of resource-and-capability configurations transmitted at 1702 may include multiple subsets of SPS configurations specifying a same set of SPS parameters, e.g., {K1, P} or {K1′, P′}. However, each of the SPS configurations specifying a same set of SPS parameters may specify a different capability indicator value. In some aspects, multiple configurations with a same set of SPS parameters may be activated with different time-offsets (e.g., time-offset 816/836 (K0/K0′)) to initiate a combined communication and EH/ET operation between two particular devices. In some aspects, the EH and/or ET resource-and-capability configurations may be transmitted via RRC signaling. For example, referring to FIGS. 8, 9, and 11, the base station 903/1103 may transmit EH/ET resource configuration 906A/1106A (e.g., including the set of SPS configurations 840) to EH device 902/1102 or may transmit EH/ET resource configuration 906B/1106B to ET device 904/1104. For example, 1702 may be performed by RF ET configuration component 2042.

At 1704, the base station may receive, at least one indication of an EH/ET capability from one or more of an ET device or an EH device. The EH capability indication may include an indication of a capability related to EH and/or a capability related to FD operation. In some aspects, the capabilities related to EH and FD operation are indicated for a set of BWPs or CCs. For example, an EH device may indicate that for a first set of BWPs (or CCs) the EH device is capable of FD operation, for a second set of BWPs (or CCs) the EH device is capable of EH and FD operations, and for a third set of BWPs (or CCs) the EH device is capable of EH operations and data transmission. In some aspects, the indication may include a number of BWPs or CCs that an EH device can support when using different capabilities. For example, an EH device may support a first number “N” of CCs when transmitting and/or receiving data, a second number “M” of CCs when harvesting energy, and a third number “L” of CCs when transmitting and/or receiving data as well as harvesting energy.

The EH capability indication may also indicate a set of waveforms supported for EH, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received. In some aspects, the supported waveforms are relevant when energy and data are not transmitted in a same transmission. Receiving the EH capability indication may include receiving an indication of a requested charging rate.

The base station may receive, an ET capability indication. The ET capability indication may include an indication of a set of BWPs or CCs for which ET is supported. In some aspects, the indication may include a number of BWPs or CCs that an ET device can support. The capability indication may also indicate a set of waveforms supported for ET, e.g., one or more of a deterministic signal, a circularly symmetric complex Gaussian random signal, an improper complex Gaussian random signal (e.g., a signal for which Real and Imaginary parts have different variances), or any other signal type via which RF energy may be transmitted and received.

Additionally, in some aspects, the ET capability indication may indicate an ability to switch between supported waveforms (e.g., a transition time) or a timing of a reference ET signal for each supported waveform. The reference ET signal for a supported waveform may be used to determine the efficiency of the supported waveform. The efficiency determination based on the reference signal may be used to determine a set of waveforms used for an EH/ET operation between an EH device and an ET device. The ET capability indication may also be received by a set of EH devices. The ET capability indication, in some aspects, may include an indication of a set of frequencies (e.g., BWPs or CCs) supported for data transmission. The ET capability indication may also include an ET power report indicating a current availability to serve as an ET node based on a power level of the ET device. For example, referring to FIGS. 9-11, the base station 903/1003/1103 may receive a capability indication 908/910/1010/1108/1110 from one or more of an ET device 904/1004/1104 or an EH device 902/1002/1102. For example, 1704, may be performed by RF ET indication component 2040.

At 1706, the base station may determine a configuration for transmission of RF energy from at least one ET device to the energy reception device based on the at least one indication of the EH capability. For example, the base station 903 may determine a set of configuration parameters (e.g., BWPs, CCs, waveforms, resources (e.g., SPS configurations), a charging rate, etc.) for EH/ET that are supported by both the ET device 904 and the EH device 902. For example, referring to FIGS. 9-11, the base station 903/1003/1103 may configure 912/1012/1112 (e.g., determine a configuration for) transmission of RF energy from ET device 904/1004/1104 to the EH device 902/1002/1102 based on the EH capability indication 908/1108 and/or the ET capability indication 910/1010/1110. For example, 1706 may be performed by RF ET configuration component 2042.

Based on the determination at 1706, the base station may transmit, at 1708, an indication of a particular EH and/or ET resource-and-capability configuration in the set of EH and/or ET resource-and-capability configurations transmitted at 1702. The indication may include one or more identifiers associated with one or more EH and/or ET resource-and-capability configurations in the set of EH and/or ET resource-and-capability configurations transmitted at 1702. For example, referring to FIGS. 9-11, the base station 903/1003/1103 may transmit an EH configuration indication 914A/1014A/1114A to the EH device 902/1002/1102 and/or the base station 903/1003/1103 may transmit an ET configuration indication 914B/1014B/1114B to the ET device 904/1004/1104 based on the determination at 912/1012/1112. For example, 1708 may be performed by RF ET configuration component 2042.

At 1710, the base station may transmit an update to the set of EH and/or ET resource-and-capability configurations transmitted at 1702. The update, at 1710, to the set of EH and/or ET resource-and-capability configurations may include at least one update to at least one EH and/or ET resource-and-capability configuration in the set of EH and/or ET resource-and-capability configurations (e.g., sets of SPS configurations 840 of FIG. 8). For example, the update may add an EH or ET resource-and-capability configuration to the set of EH and/or ET resource-and-capability configurations. Alternatively, or additionally, the update may remove an EH or ET resource-and-capability configuration to the set of EH and/or ET resource-and-capability configurations. In some aspects, the update may modify an existing EH or ET resource-and-capability configuration (e.g., modify a capability indicator, a set of SPS parameters, associated criteria/policies, etc.) in the set of EH and/or ET resource-and-capability configurations. The update to the set of EH resource-and-capability configurations may be transmitted via a MAC-CE. For example, referring to FIG. 10, the base station 1003 may transmit the EH/ET resource configuration update 1008A to the EH device 1002 and/or the base station 1003 may transmit the EH/ET resource configuration update 1008B to the ET device 1004. For example, 1710 may be performed by RF ET configuration component 2042.

At 1712, the base station may transmit an indication of an updated EH and/or ET resource-and-capability configuration included in the updated set of EH and/or ET resource-and-capability configurations. The indication may include one or more identifiers associated with one or more updated EH and/or ET resource-and-capability configurations in the set of EH and/or ET resource-and-capability configurations transmitted at 1702 as modified at 1710. For example, referring to FIG. 10, the base station 1003 may transmit the EH configuration indication 1014A to the EH device 1002 and/or the base station 1003 may transmit the ET resource configuration indication 1014B to the ET device 1004. For example, 1712 may be performed by RF ET configuration component 2042.

At 1714, the base station may receive an indication of a current ability of an ET device to serve as an ET node (e.g., a power level report) based on a power level of the ET device. The indication of a current ability of an ET device to serve as an ET node may be a periodically transmitted power level report based on a period configured, e.g., by the base station via RRC signaling. In some aspects, the periodicity of the indication is further associated with an expiration timer after which an ET device that fails to provide a power level report to the base station may stop any current ET operations. For example, referring to FIG. 10, the base station 1003 may transmit the indication of a current ability of an ET device to serve as an ET node (e.g., a power level report) in EH capability indication 1010 from the ET device 1004. For example, 1714 may be performed by RF ET indication component 2040.

Finally, at 1716, the base station may determine that the ET device does not support ET based on the power level of the ET device indicated in the indication of a current ability of an ET device to serve as an ET node or an absence of the indication (or power level report) of the current ability for a threshold amount of time. For example, the base station may determine whether the indicated particular power level is above a power level threshold such that the ET device supports ET operations, or below the threshold power level such that the ET device does not support ET operations. Additionally, the base station, may determine, based on the passing of an expiration time, that the ET device does not support ET. Based on the determination, the base station may not indicate for the ET device to participate in an ET/EH operation until a different status (e.g., a power level) is indicated by the ET device. For example, referring to FIG. 10, the base station 1003 may determine 1022, based on the passing of the expiration time 1018, and/or based on an indicated power level, that the ET device 1004 does not support ET. For example, 1716 may be performed by RF ET indication component 2040.

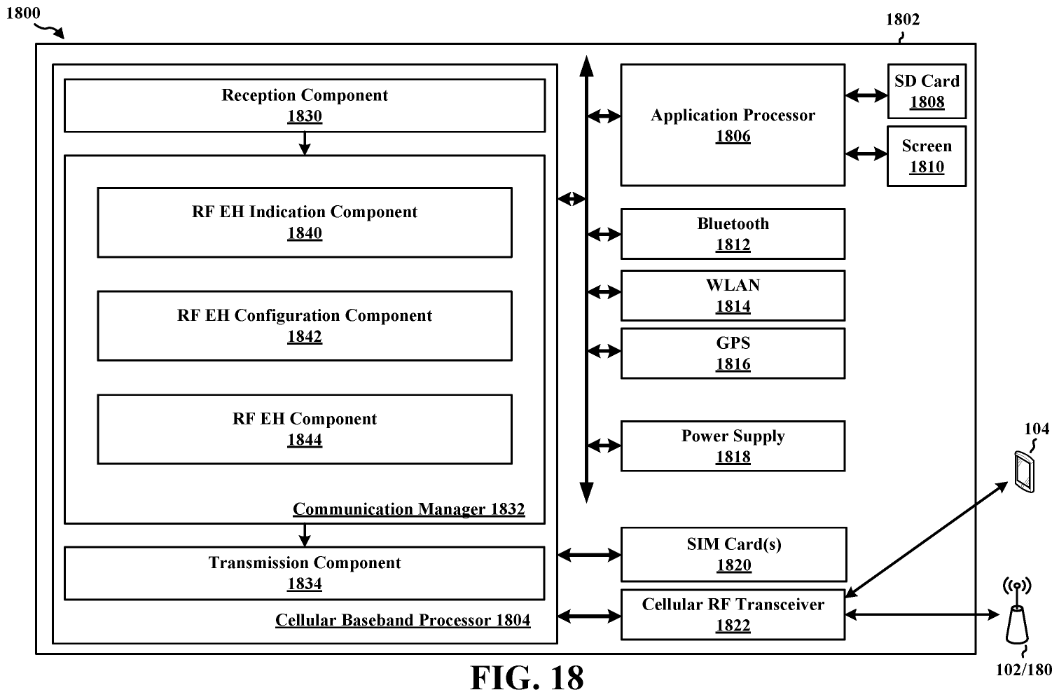

FIG. 18 is a diagram 1800 illustrating an example of a hardware implementation for an apparatus 1802. The apparatus 1802 is a UE and includes a cellular baseband processor 1804 (also referred to as a modem) coupled to a cellular RF transceiver 1822 and one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, and a power supply 1818. The cellular baseband processor 1804 communicates through the cellular RF transceiver 1822 with the UE 104 and/or BS 102/180. The cellular baseband processor 1804 may include a computer-readable medium/memory. The computer-readable medium/memory may be non-transitory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the cellular baseband processor 1804. The cellular baseband processor 1804 may be a component of the UE 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see 350 of FIG. 3) and include the additional modules of the apparatus 1802.

The communication manager 1832 includes an RF EH indication component 1840 that is configured to transmit an EH capability indication, e.g., as described in connection with 1202 and 1302 of FIGS. 12 and 13. The communication manager 1832 further includes an RF EH configuration component 1842 that may be configured to receive a set of EH resource-and-capability configurations; receive an EH configuration indication; to apply an EH configuration for receiving RF energy based on one or more of a received indication, a communicating application of the EH device, a traffic type, an SPS configuration, a traffic density associated with the EH device, or an error rate of communication at the EH device; and receive an update to the set of EH resource-and-capability configurations, e.g., as described in connection with 1306, 1308, 1310, 1314, and 1316. The communication manager 1832 further includes an RF EH component 1844 that receives input in the form of a set of parameters or characteristics associated with an RF EH operation from the RF EH configuration component 1842 and is configured to receive transmitted RF energy from at least one RF ET node, e.g., as described in connection with 1204, 1312, and 1318 of FIGS. 12 and 13.

The apparatus may include additional components that perform each of the blocks of the algorithm in the flowcharts of FIGS. 12 and 13. As such, each block in the flowcharts of FIGS. 12 and 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the cellular baseband processor 1804, includes means for transmitting an indication of an EH capability of the UE. The apparatus 1802, and in particular the cellular baseband processor 1804, further includes means for receiving, based on the transmitted indication, transmitted RF energy from at least one RF ET node. The apparatus 1802, and in particular the cellular baseband processor 1804, may further include means for transmitting a requested charging rate. The apparatus 1802, and in particular the cellular baseband processor 1804, may further include means for receiving information regarding a set of EH resource-and-capability configurations. The apparatus 1802, and in particular the cellular baseband processor 1804, may further include means for receiving an indication of a particular EH resource-and-capability configuration, where receiving the transmitted RF energy is further based on the received indication of the particular EH resource-and-capability configuration. The apparatus 1802, and in particular the cellular baseband processor 1804, may further include means for receiving an update to the set of EH resource-and-capability configurations via a MAC-CE. The apparatus 1802, and in particular the cellular baseband processor 1804, may further include means for receiving an indication of an updated EH resource-and-capability configuration comprised in the updated set of EH resource-and-capability configurations. The apparatus 1802, and in particular the cellular baseband processor 1804, may further include means for receiving additional transmitted RF energy based on the indicated updated EH resource-and-capability configuration. The apparatus 1802, and in particular the cellular baseband processor 1804, may further include means for applying an EH configuration based on one or more of: a communicating application of the UE, a traffic type, a semi-persistent scheduling configuration, a traffic density for UE, or an error rate of communication at the UE. The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means.

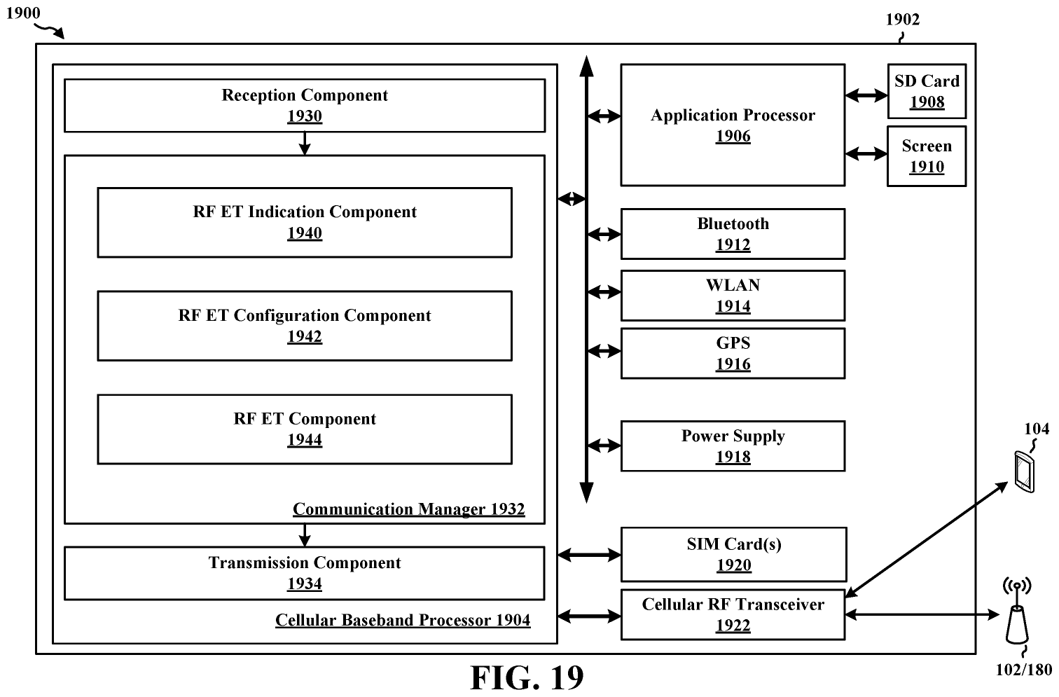

FIG. 19 is a diagram 1900 illustrating an example of a hardware implementation for an apparatus 1902. The apparatus 1902 is a UE and includes a cellular baseband processor 1904 (also referred to as a modem) coupled to a cellular RF transceiver 1922 and one or more subscriber identity modules (SIM) cards 1920, an application processor 1906 coupled to a secure digital (SD) card 1908 and a screen 1910, a Bluetooth module 1912, a wireless local area network (WLAN) module 1914, a Global Positioning System (GPS) module 1916, and a power supply 1918. The cellular baseband processor 1904 communicates through the cellular RF transceiver 1922 with the UE 104 and/or BS 102/180. The cellular baseband processor 1904 may include a computer-readable medium/memory. The computer-readable medium/memory may be non-transitory. The cellular baseband processor 1904 is responsible for general processing, including the execution of software stored on the computer-readable medium/memory. The software, when executed by the cellular baseband processor 1904, causes the cellular baseband processor 1904 to perform the various functions described supra. The computer-readable medium/memory may also be used for storing data that is manipulated by the cellular baseband processor 1904 when executing software. The cellular baseband processor 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the cellular baseband processor 1904. The cellular baseband processor 1904 may be a component of the UE 350 and may include the memory 360 and/or at least one of the TX processor 368, the RX processor 356, and the controller/processor 359. In one configuration, the apparatus 1902 may be a modem chip and include just the baseband processor 1904, and in another configuration, the apparatus 1902 may be the entire UE (e.g., see 350 of FIG. 3) and include the additional modules of the apparatus 1902.

The communication manager 1932 includes an RF ET indication component 1940 that is configured to transmit an ET capability indication and receive a request to transmit RF energy to an EH capable UE, e.g., as described in connection with 1402, 1404, 1504, and 1506 of FIGS. 14 and 15. The communication manager 1932 further includes an RF ET configuration component 1942 that may be configured to receive a set of EH resource-and-capability configurations; receive an ET configuration indication; and receive an update to the set of EH resource-and-capability configurations, e.g., as described in connection with 1502, 1508, and 1512 of FIG. 15. The communication manager 1932 further includes an RF ET component 1944 that receives input in the form of a set of parameters or characteristics associated with an RF ET operation from the RF ET configuration component 1942 and is configured to transmit, based on the received request, RF energy to the EH-capable UE and to stop transmission of the RF energy based on a timer expiring following transmission of a last indication of the current ability of the ET device to serve as the ET node, e.g., as described in connection with 1406, 1510, 1516, and 1518 of FIGS. 14 and 15.

The apparatus may include additional components that perform each of the blocks of the algorithm in the flowcharts of FIGS. 14 and 15. As such, each block in the flowcharts of FIGS. 14 and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1902, and in particular the cellular baseband processor 1904, includes means for transmitting an indication of an ET capability of the ET device. The apparatus 1902, and in particular the cellular baseband processor 1904, further includes means for receiving a request to transmit RF energy to an EH capable UE. The apparatus 1902, and in particular the cellular baseband processor 1904, may further include means for transmitting, based on the received request, RF energy to the EH-capable UE. The apparatus 1902, and in particular the cellular baseband processor 1904, may further include indicating a set of frequencies supported for data transmission. The apparatus 1902, and in particular the cellular baseband processor 1904, may further include means for transmitting an indication of a current ability of the ET device to serve as an ET node based on a power level of the ET device. The apparatus 1902, and in particular the cellular baseband processor 1904, may further include means for stopping transmission of the RF energy based on a timer expiring following transmission of a last indication of the current ability of the ET device to serve as the ET node and before the transmission of a next of the indication of the current ability of the ET device to serve as the ET node. The apparatus 1902, and in particular the cellular baseband processor 1904, may further include means for receiving a set of ET resource configurations. The apparatus 1902, and in particular the cellular baseband processor 1904, may further include means for receiving an indication of at least one particular ET resource configuration, where transmitting the RF energy is further based on the received indication of the particular ET resource configuration. The means may be one or more of the components of the apparatus 1902 configured to perform the functions recited by the means. As described supra, the apparatus 1902 may include the TX Processor 368, the RX Processor 356, and the controller/processor 359. As such, in one configuration, the means may be the TX Processor 368, the RX Processor 356, and the controller/processor 359 configured to perform the functions recited by the means.

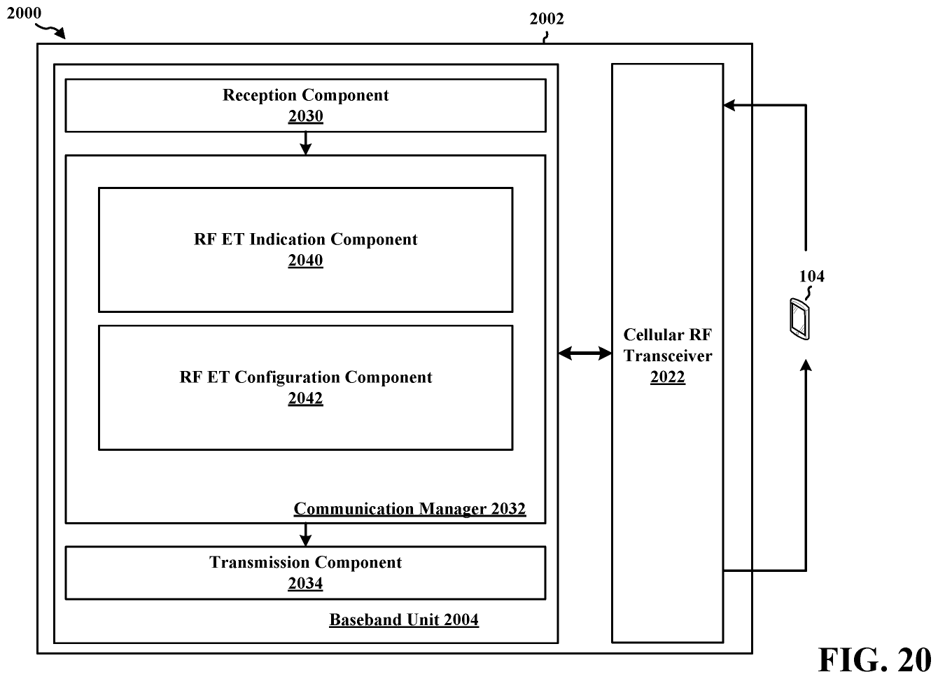

FIG. 20 is a diagram 2000 illustrating an example of a hardware implementation for an apparatus 2002. The apparatus 2002 is a BS and includes a baseband unit 2004. The baseband unit 2004 may communicate through a cellular RF transceiver 2022 with the UE 104. The baseband unit 2004 may include a computer-readable medium/memory. The baseband unit 2004 is responsible for general processing, including the execution of software stored on the computer-readable medium/memory. The software, when executed by the baseband unit 2004, causes the baseband unit 2004 to perform the various functions described supra. The computer-readable medium/memory may also be used for storing data that is manipulated by the baseband unit 2004 when executing software. The baseband unit 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the baseband unit 2004. The baseband unit 2004 may be a component of the BS 310 and may include the memory 376 and/or at least one of the TX processor 316, the RX processor 370, and the controller/processor 375.

The communication manager 2032 includes an RF ET indication component 2040 that is configured to receive at least one indication of an EH capability from one or more of an ET device or an EH device and receive an indication of a current ability of the ET device to serve as an ET node based on a power level of the ET device, e.g., as described in connection with 1602, 1704, 1714, and 1716 of FIGS. 16 and 17. The communication manager 2032 further includes an RF ET configuration component 2042 that may be configured to transmit information regarding a set of EH resource-and-capability configurations; determine a configuration for transmission of RF energy from at least one ET device to the EH device; transmit an indication of a particular EH resource-and-capability configuration for use by at least one of the ET device or the EH device; transmit an update to the set of EH resource-and-capability configurations via a MAC-CE; and transmit an indication of an updated EH resource-and-capability configuration included in the updated set of EH resource-and-capability configurations, e.g., as described in connection with 1604, 1702,1706, 1708, 1710, and 1712 of FIG. 17.

The apparatus may include additional components that perform each of the blocks of the algorithm in the flowcharts of FIGS. 16 and 17. As such, each block in the flowcharts of FIGS. 16 and 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2002, and in particular the cellular baseband processor 2004, includes means for receiving at least one indication of an EH capability from one or more of an ET device or an energy reception device. The apparatus 2002, and in particular the cellular baseband processor 2004, further includes means for configuring transmission of RF energy from at least one ET device to the energy reception device based on the at least one indication of the EH capability. The apparatus 2002, and in particular the cellular baseband processor 2004, may further include means for transmitting information regarding a set of EH resource-and-capability configurations. The apparatus 2002, and in particular the cellular baseband processor 2004, may further include means for transmitting an indication of a particular EH resource-and-capability configuration for use by at least one of the ET device or the energy reception device. The apparatus 2002, and in particular the cellular baseband processor 2004, may further include means for transmitting an update to the set of EH resource-and-capability configurations via a MAC-CE. The apparatus 2002, and in particular the cellular baseband processor 2004, may further include means for transmitting an indication of an updated EH resource-and-capability configuration comprised in the updated set of EH resource-and-capability configurations. The apparatus 2002, and in particular the cellular baseband processor 2004, may further include means for indicating for the ET device or the energy reception device to apply an EH configuration based on one or more of: a communicating application for the ET device or the energy reception device; a traffic type for the ET device or the energy reception device; a semi-persistent scheduling configuration for the ET device or the energy reception device; a traffic density for the ET device or the energy reception device; or an error rate of communication at the ET device or the energy reception device. The apparatus 2002, and in particular the cellular baseband processor 2004, may further include means for receiving an indication of a current ability of the ET device to serve as an ET node based on a power level of the ET device, where the base station configured the transmission of the RF energy from the ET device to the energy reception device based on the current ability of the ET device. The apparatus 2002, and in particular the cellular baseband processor 2004, may further include means for determining that the ET device does not support ET based on the power level of the ET device based on a message from the ET or an absence of the indication of the current ability for a threshold amount of time. The means may be one or more of the components of the apparatus 2002 configured to perform the functions recited by the means. As described supra, the apparatus 2002 may include the TX Processor 368, the RX Processor 356, and the controller/processor 359. As such, in one configuration, the means may be the TX Processor 368, the RX Processor 356, and the controller/processor 359 configured to perform the functions recited by the means.

In some aspects of wireless communication, e.g., 5G NR, devices may be capable of transferring or harvesting RF energy. RF energy harvesting may provide controllable and constant energy transfer over distance. In a fixed RF energy harvesting network, the harvested energy may be predictable and relatively stable over time due to fixed distance. Additionally, a FD and EH-capable UE (e.g., a UE that can transmit data and receive/harvest energy) may be able to capture some of its own transmitted energy. In some aspects, using a random multipath fading channel model, the energy harvested at node j (Eⱼ) from a transmitting node i may be given by Eq. 1 above

As discussed in relation to FIGS. 4-7 different devices may support different architectures, time-and-frequency resources, or different waveforms. Specifically, in a mixed network as described in relation to FIG. 6, different devices may differently support RF ET/EH capabilities. In such cases, it may be beneficial to introduce methods for identifying (e.g., indicating or communicating) common characteristics (or negotiating time-and-frequency resources and waveforms) for an EH operation between different EH/ET-capable devices. Aspects presented herein enable an EH target device and/or an ET device to indicate one or more EH related capabilities in an efficient manner.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to: transmit an indication of an EH capability of the UE; and receive, based on the transmitted indication, transmitted RF energy from at least one RF ET node.

Aspect 2 is the apparatus of aspect 1, where the EH capability includes a capability related to EH and full-duplex operation.

Aspect 3 is the apparatus of aspect 2, where the capability is for the full-duplex operation including the EH in a same BWP or a same carrier.

Aspect 4 is the apparatus of any of aspects 2 or 3, where the EH capability indicates that the UE supports one of: transmitting data and harvesting energy simultaneously; FD communication at a different time than harvesting energy; or FD communication and harvesting energy simultaneously.

Aspect 5 is the apparatus of any of aspects 1 to 4, where the EH capability of the UE indicates one or more of: a set of time-and-frequency resources which are available for EH; one or more carriers that the UE supports for EH; a number of carriers that the UE simultaneously supports for EH; and one or more waveforms supported by the UE for EH.

Aspect 6 is the apparatus of any of aspects 1 to 5, where the at least one processor is further configured to: transmit a requested charging rate.

Aspect 7 is the apparatus of any of aspects 1 to 6, where the UE indicates the requested charging rate for each of a plurality of BWPs or a plurality of carriers.

Aspect 8 is the apparatus of any of aspects 1 to 7, where the at least one processor is further configured to: receive information regarding a set of EH resource-and-capability configurations; and receive an indication of a particular EH resource-and-capability configuration, where receiving the transmitted RF energy is further based on the received indication of the particular EH resource-and-capability configuration.

Aspect 9 is the apparatus of aspect 8, where the set of capabilities comprises one or more of data transmission, data reception, or energy reception.

Aspect 10 is the apparatus of aspect 9, where a first resource-and-capability configuration indicates for the UE to perform EH without data communication for a first set of time-and-frequency resources indicated in the first resource-and-capability configuration, and a second resource-and-capability configuration indicates for the UE to perform both EH resources and data resources for a second set of time-and-frequency resources indicated in the second resource-and-capability configuration.

Aspect 11 is the apparatus of any of aspects 8 to 10, where the information regarding the set of EH resource-and-capability configurations is received via an RRC configuration and the indication of the particular EH resource-and-capability configuration is received via DCI.

Aspect 12 is the apparatus of aspect 11, where the at least one processor is further configured to: receive an update to the set of EH resource-and-capability configurations; receive an indication of an updated EH resource-and-capability configuration included in the updated set of EH resource-and-capability configurations; and receive additional transmitted RF energy based on the indicated updated EH resource-and-capability configuration.

Aspect 13 is the apparatus of any of aspects 1 to 12, where the at least one processor is further configured to: apply an EH configuration based on one or more of: a communicating application of the UE; a traffic type; a semi-persistent scheduling configuration; a traffic density for the UE; or an error rate of communication at the UE.

Aspect 14 is an apparatus for wireless communication including at least one processor coupled to a memory and configured to: transmit an indication of an ET capability of the ET device; receive a request to transmit RF energy to an EH capable UE; and transmit, based on the received request, RF energy to the EH-capable UE.

Aspect 15 is the apparatus of aspect 14, where the ET capability indicates one or more of: a set of waveforms supported for ET; a capability to switch between waveforms; and a switch time to switch between waveforms in the set of supported waveforms.

Aspect 16 is the apparatus of any of aspects 14 or 15, where the ET capability indicates a set of one or more carriers or BWPs for which ET is supported.

Aspect 17 is the apparatus of aspect 16, where the ET capability indicates a number of carriers or a number of BWPs simultaneously supported for ET.

Aspect 18 is the apparatus of any of aspects 16 or 17, where the ET device indicates a charging rate for each of a plurality of BWPs or a plurality of carriers.

Aspect 19 is the apparatus of any of aspects 16 to 18, where the at least one processor is further configured to: indicate a set of frequencies supported for data transmission.

Aspect 20 is the apparatus of any of aspects 14 to 19, where the at least one processor is further configured to: transmit an indication of a current ability of the ET device to serve as an ET node based on a power level of the ET device.

Aspect 21 is the apparatus of any of aspects 14 to 20, where the at least one processor is further configured to: stop transmission of the RF energy based on a timer expiring following transmission of a last indication of the current ability of the ET device to serve as the ET node and before the transmission of a next of the indication of the current ability of the ET device to serve as the ET node.

Aspect 22 is the apparatus of any of aspects 14 to 21, where the received request indicates at least one of: a set of waveforms supported by the EH-capable UE; a requested charging rate; a requested charging duration; or a set of resources available for receiving the RF energy at the EH-capable UE.

Aspect 23 is the apparatus of any of aspects 14 to 22, where the request is received from a base station and indicates the EH-capable UE.

Aspect 24 is the apparatus of any of aspects 14 to 23, where the at least one processor is further configured to: receive a set of ET resource configurations; and receive an indication of at least one particular ET resource configuration, where transmitting the RF energy is further based on the received indication of the particular ET resource configuration.

Aspect 25 is the apparatus of aspect 24, where each ET resource configuration in the set of ET resource configurations includes information regarding first resources available for ET and second resources available for data transmission and reception.

Aspect 26 is an apparatus for wireless communication including at least one processor coupled to a memory and configured to: receive at least one indication of an EH capability from one or more of an ET device or an energy reception device; and configure transmission of RF energy from at least one ET device to the energy reception device based on the at least one indication of the EH capability.

Aspect 27 is the apparatus of aspect 26, where the EH capability includes a capability related to EH and full-duplex operation.

Aspect 28 is the apparatus of aspect 27, where the EH capability is for the full-duplex operation including the EH in a same BWP or a same carrier.

Aspect 29 is the apparatus of any of aspects 27 or 28, where the EH capability includes an indication that the energy reception device supports one of: transmitting data and harvesting energy simultaneously; FD communication at a different time than harvesting energy; or FD communication and harvesting energy simultaneously.

Aspect 30 is the apparatus of any of aspects 26 to 29, where the EH capability indicates support for one or more waveforms supported for EH.

Aspect 31 is the apparatus of aspect 30, where the EH capability further indicates a capability to switch between waveforms.

Aspect 32 is the apparatus of any of aspects 30 or 31, where the EH capability further indicates a switch time to switch between waveforms.

Aspect 33 is the apparatus of any of aspects 26 to 32, where the EH capability indicates a set of time-and-frequency resources which are available for EH.

Aspect 34 is the apparatus of any of aspects 26 to 33, where the EH capability indicates one or more carriers supported for EH.

Aspect 35 is the apparatus of any of aspects 26 to 34, where the EH capability indicates a number of carriers supported for accumulated EH.

Aspect 36 is the apparatus of any of aspects 26 to 35, where the EH capability indicates a charging rate for ET or energy reception.

Aspect 37 is the apparatus of aspect 36, where the base station receives the charging rate for each of a plurality of BWPs or a plurality of carriers.

Aspect 38 is the apparatus of any of aspects 26 to 37, where the at least one processor is further configured to: transmit information regarding a set of EH resource-and-capability configurations; and transmit an indication of a particular EH resource-and-capability configuration for use by at least one of the ET device or the energy reception device.

Aspect 39 is the apparatus of aspect 28, where each capability configuration includes a configuration for one or more of data transmission, data reception, or energy reception.

Aspect 40 is the apparatus of aspect 39, where a first capability configuration indicates for the energy reception device to perform EH without data communication for a first configuration period of time, and a second capability configuration indicates for the energy reception device to perform both EH resources and data resources for a second configured period of time.

Aspect 41 is the apparatus of any of aspects 28 to 40, where the information regarding the set of EH resource-and-capability configurations is transmitted via an RRC configuration and the indication of the particular EH resource-and-capability configuration is transmitted via DCI.

Aspect 42 is the apparatus of any of aspects 28 to 41, where the at least one processor is further configured to: transmit an update to the set of EH resource-and-capability configurations via a MAC-CE; and transmit an indication of an updated EH resource-and-capability configuration included in the updated set of EH resource-and-capability configurations.

Aspect 43 is the apparatus of any of aspects 26 to 42, where the at least one processor is further configured to indicate for the ET device or the energy reception device to apply an EH configuration based on one or more of: a communicating application for the ET device or the energy reception device; a traffic type for the ET device or the energy reception device; a semi-persistent scheduling configuration for the ET device or the energy reception device; a traffic density for the ET device or the energy reception device; or an error rate of communication at the ET device or the energy reception device.

Aspect 44 is the apparatus of any of aspects 26 to 43, where the at least one processor is further configured to: receive an indication of a current ability of the ET device to serve as an ET node based on a power level of the ET device, where the base station configured the transmission of the RF energy from the ET device to the energy reception device based on the current ability of the ET device.

Aspect 45 is the apparatus of aspect 44, where the at least one processor is further configured to: determine that the ET device does not support ET based on the power level of the ET device based on a message from the ET or an absence of the indication of the current ability for a threshold amount of time.

Aspect 46 is the apparatus of any of aspects 26 to 45, where the base station configures the RF transmission from a plurality of ET devices to the energy reception device based on the received EH capability.

Aspect 47 is the apparatus of any of aspects 26 to 46, where the base station configures the RF transmission from a single ET device to a plurality of energy reception devices based on the received EH capability.

Aspect 48 is a method of wireless communication for implementing any of aspects 1 to 47.

Aspect 49 is an apparatus for wireless communication including means for implementing any of aspects 1 to 47.

Aspect 50 is a computer-readable medium storing computer executable code, where the code when executed by a processor causes the processor to implement any of aspects 1 to 47.

What is claimed is:

1. An apparatus for wireless communication at a user equipment (UE), comprising:
a memory; and
at least one processor coupled to the memory and configured to:
transmitting an indication of an energy harvesting (EH) capability of the UE; and
receiving, based on the transmitted indication, transmitted radio frequency (RF) energy from at least one RF energy transfer (ET) node.

2. The apparatus of claim 1, wherein the EH capability comprises a capability related to EH and full-duplex operation.

3. The apparatus of claim 2, wherein the EH capability is for the full-duplex operation including the EH in a same bandwidth part (BWP) or a same carrier.

4. The apparatus of claim 2, wherein the EH capability indicates that the UE supports one of:
transmitting data and harvesting energy simultaneously,
full duplex (FD) communication at a different time than harvesting energy, or
FD communication and harvesting energy simultaneously.

5. The apparatus of claim 1, wherein the EH capability of the UE indicates one or more of:
a set of time-and-frequency resources which are available for EH;
one or more carriers that the UE supports for EH;
a number of carriers that the UE simultaneously supports for EH; and
one or more waveforms supported by the UE for EH.

6. The apparatus of claim 1, wherein the at least one processor is further configured to:
transmit a requested charging rate.

7. The apparatus of claim 6, wherein the UE indicates the requested charging rate for each of a plurality of bandwidth parts (BWPs) or a plurality of carriers.

8. The apparatus of claim 1, wherein the at least one processor is further configured to:
receive information regarding a set of EH resource-and-capability configurations, each resource-and-capability configuration comprising an indication of (1) a set of time-and-frequency resources and (2) a set of capabilities associated with the indicated set of time-and-frequency resources; and
receive an indication of a particular EH resource-and-capability configuration, wherein receiving the transmitted RF energy is further based on the received indication of the particular EH resource-and-capability configuration.

9. The apparatus of claim 8, wherein the set of capabilities comprises one or more of data transmission, data reception, or energy reception.

10. The apparatus of claim 9, wherein a first resource-and-capability configuration indicates for the UE to perform EH without data communication for a first set of time-and-frequency resources indicated in the first resource-and-capability configuration, and a second resource-and-capability configuration indicates for the UE to perform both EH resources and data resources for a second set of time-and-frequency resources indicated in the second resource-and-capability configuration.

11. The apparatus of claim 8, wherein the information regarding the set of EH resource-and-capability configurations is received via a radio resource control (RRC) configuration and the indication of the particular EH resource-and-capability configuration is received via downlink control information (DCI).

12. The apparatus of claim 11, wherein the at least one processor is further configured to:
receive an update to the set of EH resource-and-capability configurations;
receive an indication of an updated EH resource-and-capability configuration comprised in the updated set of EH resource-and-capability configurations; and
receive additional transmitted RF energy based on the indicated updated EH resource-and-capability configuration.

13. The apparatus of claim 1, wherein the at least one processor is further configured to:
apply an EH configuration based on one or more of:
a traffic type,
a semi-persistent scheduling configuration,
a traffic density for the UE, or
an error rate of communication at the UE.

14. An apparatus for wireless communication at an energy transfer (ET) device, comprising:
a memory; and
at least one processor coupled to the memory and configured to:
transmit an indication of an ET capability of the ET device;
receive a request to transmit RF energy to an energy harvesting (EH) capable UE; and
transmit, based on the received request, RF energy to the EH-capable UE.

15. The apparatus of claim 14, wherein the ET capability indicates one or more of:
a set of waveforms supported for ET;
a capability to switch between waveforms; and
a switch time to switch between waveforms in the set of supported waveforms.

16. The apparatus of claim 14, wherein the ET capability indicates a set of one or more carriers or bandwidth parts (BWPs) for which ET is supported.

17. The apparatus of claim 16, wherein the ET capability indicates a number of carriers or a number of BWPs simultaneously supported for ET.

18. The apparatus of claim 16, wherein the ET device indicates a transmission power characteristic for each of a plurality of BWPs or a plurality of carriers.

19. The apparatus of claim 16, wherein the at least one processor is further configured to:
indicate a set of frequencies supported for data transmission.

20. The apparatus of claim 14, wherein the at least one processor is further configured to:
transmit an indication of a current ability of the ET device to serve as an ET node based on a power level of the ET device.

21. The apparatus of claim 20, wherein the at least one processor is further configured to:
stop transmission of the RF energy based on a timer expiring following transmission of a last indication of the current ability of the ET device to serve as the ET node and before the transmission of a next of the indication of the current ability of the ET device to serve as the ET node.

22. The apparatus of claim 14, wherein the received request indicates at least one of:
a set of waveforms supported by the EH-capable UE,
a requested charging rate,
a requested charging duration, or
a set of resources available for receiving the RF energy at the EH-capable UE.

23. The apparatus of claim 14, wherein the request is received from a base station and indicates the EH-capable UE.

24. The apparatus of claim 14, wherein the at least one processor is further configured to:
receive a set of ET resource configurations; and
receive an indication of at least one particular ET resource configuration, wherein transmitting the RF energy is further based on the received indication of the particular ET resource configuration.

25. The apparatus of claim 24, wherein each ET resource configuration in the set of ET resource configurations includes information regarding first resources available for ET and second resources available for data transmission and reception.

26. A method of wireless communication at a user equipment (UE), comprising:
transmitting an indication of an energy harvesting (EH) capability of the UE; and
receiving, based on the transmitted indication, transmitted radio frequency (RF) energy from at least one RF energy transfer (ET) node.

27. The method of claim 26, further comprising:
receiving information regarding a set of EH resource-and-capability configurations, each resource-and-capability configuration comprising an indication of (1) a set of time-and-frequency resources and (2) a set of capabilities associated with the indicated set of time-and-frequency resources, wherein the set of capabilities comprises one or more of data transmission, data reception, or energy reception; and
receiving an indication of a particular EH resource-and-capability configuration, wherein receiving the transmitted RF energy is further based on the received indication of the particular EH resource-and-capability configuration.

28. The method of claim 27, wherein a first resource-and-capability configuration indicates for the UE to perform EH without data communication for a first set of time-and-frequency resources indicated in the first resource-and-capability configuration, and a second resource-and-capability configuration indicates for the UE to perform both EH resources and data resources for a second set of time-and-frequency resources indicated in the second resource-and-capability configuration.

29. A method of wireless communication at an energy transfer (ET) device comprising:
transmitting an indication of an ET capability of the ET device;
receiving a request to transmit RF energy to an energy harvesting (EH) capable UE; and
transmitting, based on the received request, RF energy to the EH-capable UE.

30. The method of claim 29, wherein the method further comprises:
receiving a set of ET resource configurations, wherein each ET resource configuration in the set of ET resource configurations includes information regarding first resources available for ET and second resources available for data transmission and reception; and
receiving an indication of at least one particular ET resource configuration, wherein transmitting the RF energy is further based on the received indication of the particular ET resource configuration.
